(19) United States
(12) Patent Application Publication
(10) Pub. No.: US 2021/0199873 A1
(43) Pub. Date: Jul. 1, 2021

(54) DUAL-SIDE ANTIREFLECTION COATINGS FOR BROAD ANGULAR AND WAVELENGTH BANDS

(71) Applicant: Facebook Technologies, LLC, Menlo Park, MA (US)

(72) Inventors: Yu SHI, Redmond, WA (US); Hee Yoon LEE, Kirkland, WA (US); Ningfeng HUANG, Redmond, WA (US); Giuseppe CALAFIORE, Redmond, WA (US); Pasi SAARIKKO, Kirkland, WA (US)

(21) Appl. No.: 16/727,804

(22) Filed: Dec. 26, 2019

(51) Int. Cl. F21V 8/00; G02B 27/01; G02B 27/00

(52) U.S. Cl. CPC G02B 6/0016; G02B 27/0172; G02B 27/0093; G02B 6/0031; G02B 6/0026

(57) ABSTRACT

A waveguide display includes a first substrate having two opposing sides, a grating on a first side of the two opposing sides of the first substrate and configured to couple display light into or out of the first substrate, a first antireflection layer on a first surface of the grating and configured to reduce reflection of visible light at the first surface of the grating, and a second antireflection layer on a second side of the two opposing sides of the first substrate and configured to reduce reflection of the visible light at the second side of the first substrate.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using a diffractive optical element, such as a grating. Light from the surrounding environment may pass through a see-through region of the waveguide and reach the user's eyes as well.

### SUMMARY

This disclosure relates generally to near-eye display systems, and more specifically to near-eye displays with reduced optical artifacts, such as glare or ghost images. In one embodiment, a waveguide-based near-eye display may include diffraction grating couplers that may diffractively couple display light into or out of a waveguide and refractively transmit ambient light through the waveguide. The grating couplers may include one or more grating layers that can cause destructive interference between ambient light diffracted by at least two grating layers or between ambient light diffracted by different portions of a grating layer to reduced artifacts (e.g., ghost images and chromatic dispersion) caused by ambient light. An antireflection layer may be placed on each of two opposite surfaces of the waveguide to further reduce the artifacts caused by reflected light from external light sources, due to, for example, see-through reflection and small grazing angle reflection. The antireflection layers may transmit light in a broad wavelength range and a broad incident angular range, while allowing (e.g., by refracting) ambient light within the see-through field of view of the near-eye display to pass through and reach user's eyes with little or no haze or contrast degradation. Various inventive embodiments are described herein, including devices, systems, methods, materials, and the like.

According to certain embodiments, a waveguide display may include a first substrate including two opposing sides, a grating on a first side of the two opposing sides of the first substrate and configured to couple display light into or out of the first substrate, a first antireflection layer on a first surface of the grating and configured to reduce reflection of visible light at the first surface of the grating, and a second antireflection layer on a second side of the two opposing sides of the first substrate and configured to reduce reflection of the visible light at the second side of the first substrate. In some embodiments, the first antireflection layer or the second antireflection layer may have a reflectivity less than about 5%, such as less than about 3%, for visible light with incident angles less than 75°. In some embodiments, the first substrate may include a curved substrate.

In some embodiments of the waveguide display, the first antireflection layer or the second antireflection layer may include two or more layers characterized by different respective effective refractive indices less than a refractive index of the first substrate. In some embodiments, at least one of the first antireflection layer or the second antireflection layer may include an array of micro-structures. The micro-structures may include, for example, vertical ridges, pillars, tapered ridges, or cones. The array of micro-structures may be in a material layer characterized by a first refractive index lower than a second refractive index of the first substrate. In some embodiments, the period of the array of micro-structures may be less than a half of a period of the grating.

In some embodiments, the grating may include one or more grating layers configured to cause destructive interference between ambient light diffracted by at least two grating layers or between ambient light diffracted by different portions of one grating layer. In some embodiments, the grating may include a slanted grating that includes a plurality of slanted ridges, where the slanted grating may be characterized by a height, a period, and a slant angle of the plurality of slanted ridges configured to cause destructive interference between ambient light diffracted by different portions of the slanted grating. In some embodiments, the grating may include at least two grating layers, where the at least two grating layers may be characterized by a same grating period and may be offset horizontally by a half of the grating period. In some embodiments, the waveguide display may also include a second grating between the first substrate and the second antireflection layer, where the grating and the second grating may be configured to diffract display light of different respective colors or display light for different respective fields of view.

In some embodiments, the waveguide display may further include a second substrate, a second grating on a first side of the second substrate and configured to couple display light into or out of the second substrate, a third antireflection layer on a first surface of the second grating, and a fourth antireflection layer on a second side of the second substrate opposing the second grating. The grating and the second grating may be configured to diffract display light of different respective colors or display light for different respective fields of view. The third antireflection layer may be configured to reduce reflection of the visible light at the first surface of the second grating. The fourth antireflection layer may be configured to reduce reflection of the visible light at the second side of the second substrate.

In some embodiments, the waveguide display may include a second substrate, a second grating on a first side of the second substrate and configured to diffract invisible light, a third antireflection layer on a first surface of the second grating and configured to reduce reflection of the visible light at the first surface of the second grating, and a fourth antireflection layer on a second side of the second substrate opposing the second grating and configured to reduce reflection of the visible light at the second side of the second substrate. In some embodiments, the waveguide display may include an angular-selective transmissive layer configured to reflect, diffract, or absorb ambient light incident on the angular-selective transmissive layer with an incidence angle greater than a threshold value.

According to certain embodiments, a near-eye display may include a waveguide including a first surface and a second surface opposing the first surface, an input coupler configured to couple display light from an image source into the waveguide, an output coupler coupled to the first surface of the waveguide, and a first antireflection layer for visible light on the output coupler, and a second antireflection layer for visible light on the second surface of the waveguide. The output coupler may be configured to refractively transmit ambient light and diffractively couple the display light out of the waveguide.

In some embodiments of the near-eye display, the first antireflection layer may include an array of micro-structures in a material layer characterized by a first refractive index lower than a second refractive index of the waveguide or the output coupler. The array of micro-structures may include, for example, a one-dimensional or two-dimensional array of ridges, pillars, tapered pillars, or cones. A period of the array of micro-structures may be less than a half of a period of the output coupler. In some embodiments, the output coupler may include one or more grating layers and may be configured to cause destructive interference between ambient light diffracted by at least two grating layers or between ambient light diffracted by different portions of one grating layer.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates propagations of display light and external light in an example of a waveguide display.

FIG. 6A illustrates the propagation of external light in an example of a waveguide display with a grating coupler on the front side of the waveguide display. FIG. 6B illustrates the propagation of external light in an example of a waveguide display with a grating coupler on the back side of the waveguide display.

FIG. 7 illustrates rainbow artifacts in an example of a waveguide display.

FIG. 8A illustrates an example of a grating coupler with reduced rainbow artifacts according to certain embodiments. FIG. 8B illustrates an example of a waveguide display including an angular-selective transmissive layer according to certain embodiments.

FIG. 9A illustrates light reflection at an interface between two example materials.

FIG. 9B illustrates reflectivity as a function of the light incident angle at the interface between the two example materials.

FIG. 10A illustrates rainbow artifacts caused by light reflection at a surface of an example of a waveguide display according to certain embodiments. FIG. 10B illustrates an example of a waveguide display having an antireflection layer for reducing rainbow artifacts caused by light reflection at a surface of the waveguide display according to certain embodiments.

FIG. 11A illustrates rainbow artifacts caused by light reflection at a surface of a grating coupler in an example of a waveguide display according to certain embodiments. FIG. 11B illustrates an example of a waveguide display having an antireflection layer for reducing rainbow artifacts caused by light reflection at a surface of the grating coupler according to certain embodiments.

FIG. 12A illustrates an example of an antireflection structure according to certain embodiments. FIG. 12B illustrates reflectivity of the example of the antireflection structure shown in FIG. 12A as a function of the light incident angle.

FIG. 13A illustrates an example of an antireflection structure according to certain embodiments. FIG. 13B illustrates reflectivity of the example of the antireflection structure shown in FIG. 13A as a function of the light incident angle.

FIG. 14A illustrates an example of an antireflection structure according to certain embodiments. FIG. 14B illustrates reflectivity of the example of the antireflection structure shown in FIG. 14A as a function of the light incident angle.

FIG. 15A illustrates an example of an antireflection structure according to certain embodiments. FIG. 15B illustrates reflectivity of the example of the antireflection structure shown in FIG. 15A as a function of the light incident angle.

FIG. 16A illustrates an example of an antireflection structure according to certain embodiments. FIG. 16B illustrates reflectivity of the example of the antireflection structure shown in FIG. 16A as a function of the light incident angle.

FIG. 17A illustrates rainbow artifacts caused by reflective diffraction of ambient light from the back side of an example of a waveguide display. FIG. 17B illustrates rainbow artifacts in an example of a waveguide display that includes two or more substrates.

FIG. 18A illustrates rainbow artifacts caused by light reflection at a surface of a substrate and reflective diffraction of the reflected light in an example of a waveguide display that includes two or more substrates. FIG. 18B illustrates rainbow artifact reduction in an example of a waveguide display including two or more substrates according to certain embodiments.

FIG. 19 illustrates an example of a waveguide display including dual-side antireflection coatings according to certain embodiments.

FIG. 20 illustrates an example of a waveguide display including dual-side antireflection coatings and an angular-selective transmissive layer according to certain embodiments

FIG. 21 illustrates an example of a waveguide display including two or more substrates each including dual-side antireflection coatings according to certain embodiments.

FIG. 22 is a simplified block diagram of an example electronic system of an example near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to near-eye display systems. More specifically, and without limitation, disclosed herein are near-eye displays with reduced glare or ghost images. The near-eye displays may include grating couplers that cause destructive interference between ambient light diffracted by two or more grating layers of the grating couplers to reduce the diffraction of incident ambient light (e.g., ambient light with large incident angles) by the grating couplers. The near-eye displays may also include antireflection coatings to reduce reflected ambient light that may be diffracted by the grating couplers to user's eyes to cause optical artifacts. The antireflection coatings may transmit light in a broad wavelength range and a broad incident angular range, while allowing ambient light within the see-through field of view of the near-eye display to pass through without being diffracted and reach user's eyes with little or no haze or contrast degradation. Various inventive embodiments are described herein, including devices, systems, methods, materials, and the like.

In some near-eye displays, light may be coupled into or out of the waveguide using a diffractive optical element, such as a grating. The grating may diffract both the light of the projected image and light from the surrounding environment (e.g., from a light source, such as a lamp or the sun). The diffracted portion of the light from ambient light sources and with large incident angles may appear as a ghost image to the user of a near-eye display. In addition, due to the wavelength dependent characteristics of the grating, ghost images of different colors may appear at different locations or angles. These ghost images may negatively impact the user experience of using the near-eye display. Transmissive or reflective gratings used as input or output couplers can be designed to refract ambient light within the field of view, while directing ambient light with large incident angles out of the eyebox of the near-eye display to reduce the optical artifacts. However, the ambient light diffracted, transmitted, or reflected by a grating at one surface of a waveguide may be at least partially reflected by an opposing surface of the waveguide or a surface of another waveguide in a stack due to, for example, Fresnel reflection, and may reach the grating again. The reflected light may be diffracted by the grating towards the user's eyes to cause rainbow images or other optical artifacts. For example, in some embodiments, a system may include two or more substrates or waveguides, where some ambient light with large incident angles may pass through a first substrate and may then be reflected back to the first substrate when incident on the second substrate, and a grating on the first substrate may diffract the ambient light towards the user's eyes to cause rainbow images.

According to certain embodiments, a display system may include a substrate, a grating on one of two opposing surfaces of the substrate, and antireflection layers on the opposing surfaces of the substrate. In some embodiments, the display system may include two or more substrates, where at least one of the two or more substrates may include antireflection layers on two opposing surfaces of the substrate. The antireflection layers may reduce the see-through reflection and the small grazing angle reflection of ambient light within broad wavelength and angular ranges. For example, the antireflection layers may have a low reflectivity (below about 5% or about 3%) for ambient light with wavelengths between 450 nm and 600 nm and with incidence angles within 0-50° (for see-through quality) and a low reflectivity (below about 5% or about 3%) for ambient light with incidence angles within about 50-75 degrees (for rainbow reduction). The antireflection layer may include either multiple uniform layers of different materials or periodic structures (with a small period for large diffraction angles), and may not increase see-through haze or degrade the display contrast.

In some embodiments, the antireflection layer may be implemented using two or more layers of different materials with different refractive indices, where one or more of the two or more layers may include a material with a low refractive index. In some embodiments, the low refractive index may be achieved using one-dimensional or two-dimensional periodic structures with low filling factors or small duty cycles. In some embodiments, the antireflection layer may be implemented using a multi-layer AR coating with gradient refractive index. In some embodiments, the multi-layer AR coating with gradient refractive index may be achieved using one-dimensional or two-dimensional periodic structures (e.g., tapered ridges or cones), where the width of the ridges or cones (and thus the filling factor and the effective refractive index of the periodic structures) may gradually reduce.

Techniques disclosed herein may reduce the diffraction of ambient light, reduce see-through reflection, reduce small grazing angle reflection, and thus reduce optical artifacts, such as rainbow images. The antireflection structures may work for broad wavelength and angular ranges, and may not result in see-through haze, and not degrade display contrast.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

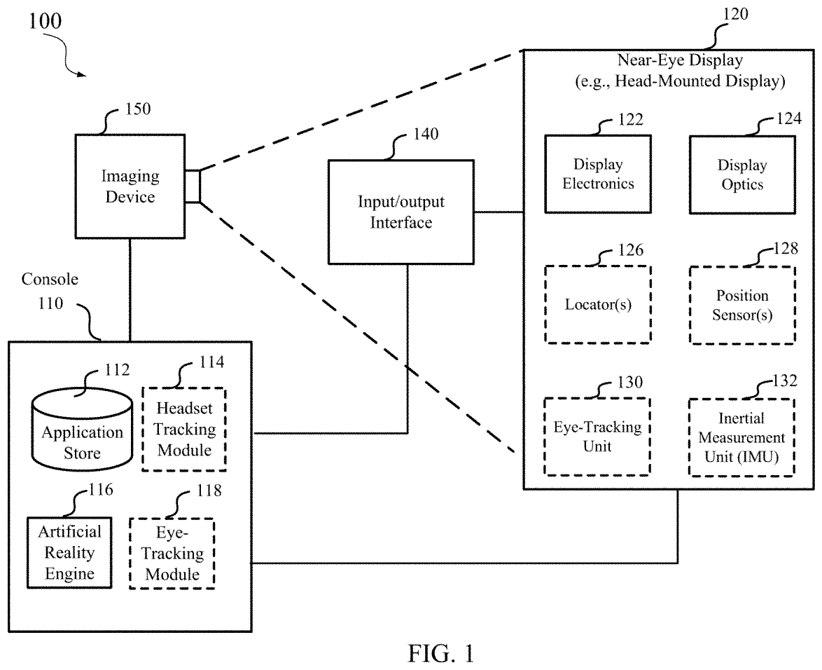

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

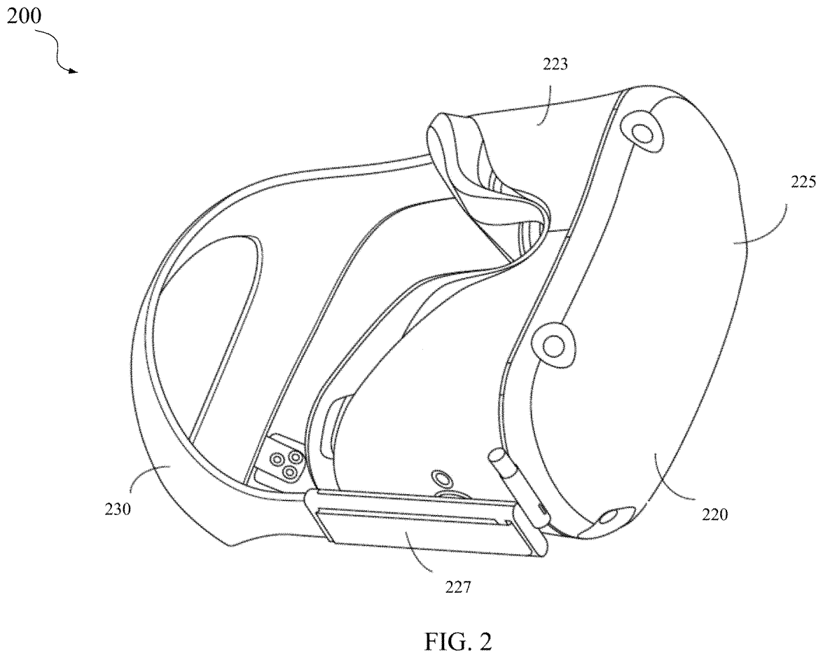

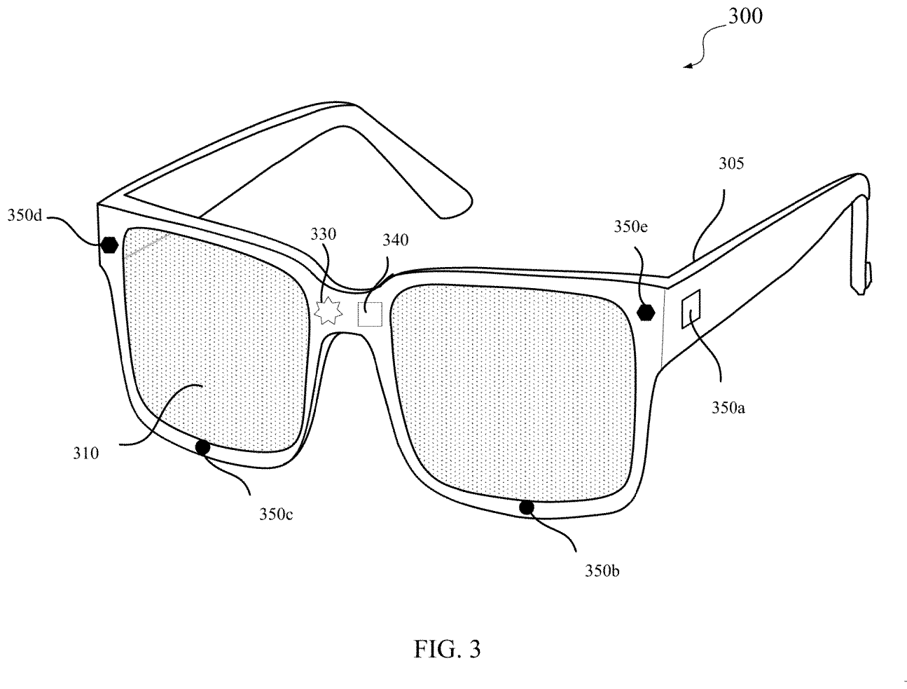

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

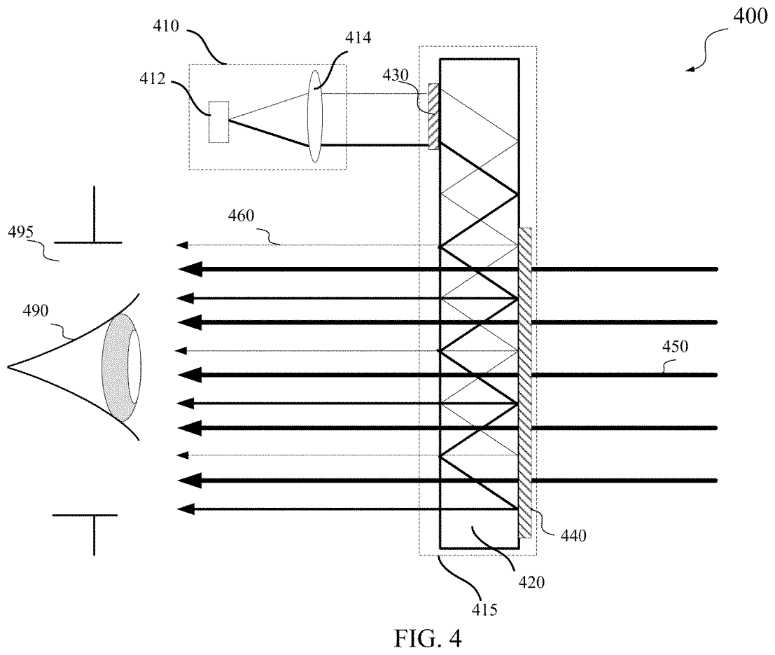

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements (DOEs), prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

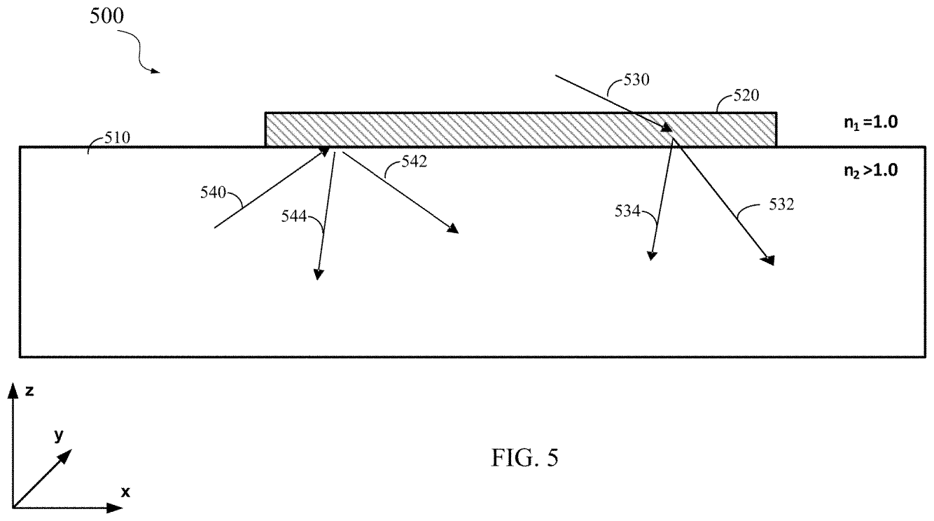

FIG. 5 illustrates propagations of display light 540 and external light 530 in an example waveguide display 500 including a waveguide 510 and a grating coupler 520. Waveguide 510 may be a flat or curved transparent substrate with a refractive index n₂ greater than the free space refractive index n₁ (e.g., 1.0). Grating coupler 520 may be, for example, a Bragg grating or a surface-relief grating.

Display light 540 may be coupled into waveguide 510 by, for example, input coupler 430 of FIG. 4 or other couplers (e.g., a prism or slanted surface) described above. Display light 540 may propagate within waveguide 510 through, for example, total internal reflection. When display light 540 reaches grating coupler 520, display light 540 may be diffracted by grating coupler 520 into, for example, a 0^{th} order diffraction (i.e., reflection) light 542 and a −1st order diffraction light 544. The 0^{th} order diffraction may propagate within waveguide 510, and may be reflected by the bottom surface of waveguide 510 towards grating coupler 520 at a different location. The −1st order diffraction light 544 may be coupled (e.g., refracted) out of waveguide 510 towards the user's eye, because a total internal reflection condition may not be met at the bottom surface of waveguide 510 due to the diffraction angle.

External light 530 may also be diffracted by grating coupler 520 into, for example, a 0^{th} order diffraction light 532 and a −1st order diffraction light 534. Both the 0^{th} order diffraction light 532 and the −1st order diffraction light 534 may be refracted out of waveguide 510 towards the user's eye. Thus, grating coupler 520 may act as an input coupler for coupling external light 530 into waveguide 510, and may also act as an output coupler for coupling display light 540 out of waveguide 510. As such, grating coupler 520 may act as a combiner for combining external light 530 and display light 540. In general, the diffraction efficiency of grating coupler 520 (e.g., a surface-relief grating coupler) for external light 530 (i.e., transmissive diffraction) and the diffraction efficiency of grating coupler 520 for display light 540 (i.e., reflective diffraction) may be similar or comparable.

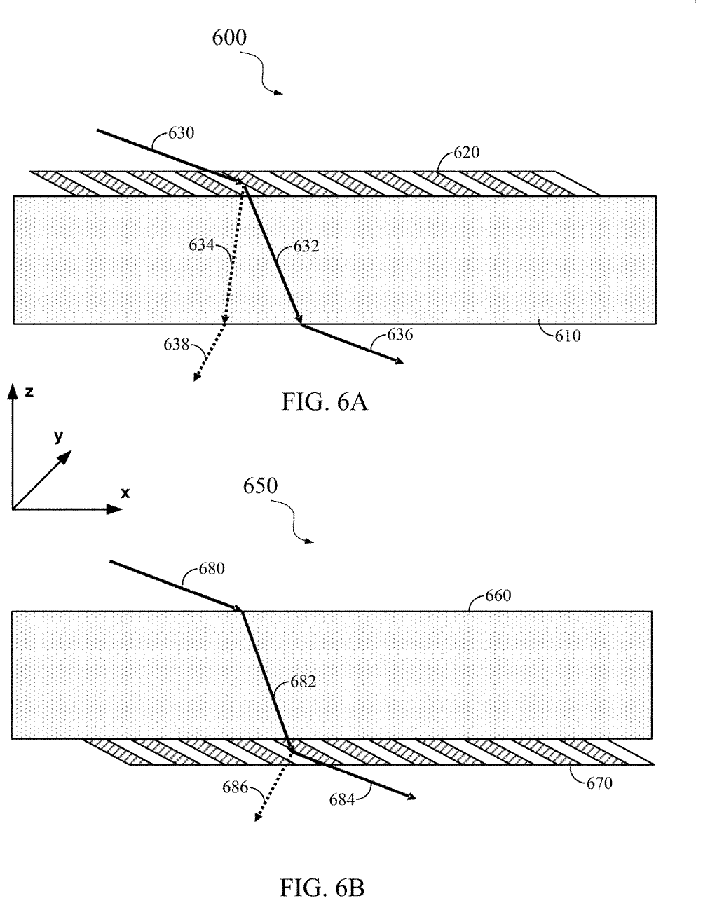

FIG. 6A illustrates the propagation of external light 630 in an example of a waveguide display 600 with a grating coupler 620 on the front side of a waveguide 610. External light 630 may be diffracted by grating coupler 620 into a 0^{th} order diffraction light 632 and a −1st order diffraction light 634. The 0^{th} order diffraction light 632 may be refracted out of waveguide 610 in a direction shown by a light ray 636, which may not reach the eyebox or user's eyes. The −1^{st} order diffraction light 634 may be refracted out of waveguide 610 in a direction shown by a light ray 638, which may reach the eyebox and user's eyes. For different wavelengths (colors), the 0^{th} order diffraction light may have a same diffraction angle, but the −1st order diffraction light may be wavelength dependent and thus may have different diffraction angles for light of different wavelengths to cause rainbow images.

FIG. 6B illustrates the propagation of external light 680 in an example of a waveguide display 650 with a grating coupler 670 on the back side of a waveguide 660. External light 680 may be refracted into waveguide 660 as refracted light 682. Refracted light 682 may then be diffracted out of waveguide 660 by grating coupler 670 into a 0^{th} order diffraction light 684 and a −1st order diffraction light 686. The propagation direction of the 0^{th} order diffraction light 684 may be similar to the propagation direction of light ray 636, and thus may not reach the eyebox or user's eyes. The propagation direction of the −1st order diffraction light 686 may be similar to the propagation direction of light ray 638, and thus may reach the eyebox or user's eyes. For different wavelengths (colors), the 0^{th} order diffraction light may have a same diffraction angle, but the −1st order diffraction light may be wavelength dependent and thus may have different diffraction angles for light of different wavelengths to cause rainbow images.

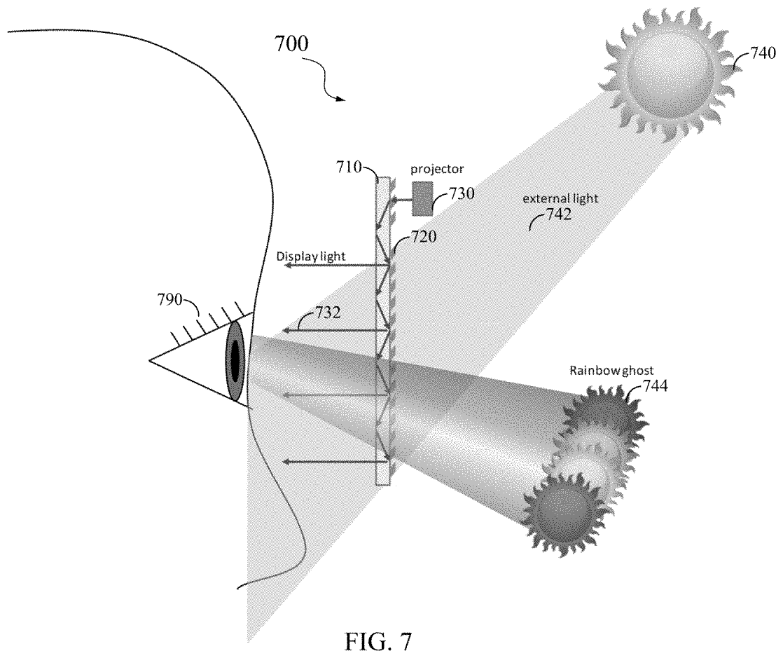

FIG. 7 illustrates rainbow artifacts in an example of a waveguide display 700. As described above, waveguide display 700 may include a waveguide 710, a grating coupler 720, and a projector 730. Display light 732 from projector 730 may be coupled into waveguide 710, and may be partially coupled out of waveguide 710 at different locations by grating coupler 720 to reach a user's eye 790. External light 742 from an external light source 740, such as the sun or a lamp, may also be diffracted by grating coupler 720 into waveguide 710 and may then propagate through waveguide 710 to reach user's eye 790.

As described above with respect to FIG. 5 and FIGS. 6A and 6B, the grating coupler may not only diffract the display light, but also diffract the external light. In addition, as described above with respect to FIGS. 6A-6B, due to the chromatic dispersion of the grating, lights of different colors may be diffracted at different angles for diffraction orders greater or less than zero. As such, the −1st order diffractions of external light of different colors that reach the user's eye (e.g., diffraction light 686 or light ray 638) may appear as ghost images located at different locations (or directions), which may be referred to as a rainbow artifact or rainbow ghost 744. Rainbow ghost 744 may appear on top of the displayed image or the image of the environment, and disrupt the displayed image or the image of the environment. Rainbow ghost 744 may significantly impact the user experience. In some cases, rainbow ghost 744 may also be dangerous to user's eye 790 when the light from external light source 740 (e.g., the sun) is directed to user's eye 790 with a high efficiency.

The rainbow ghost caused by the diffraction of external light by a grating coupler of a waveguide display may be reduced using certain techniques disclosed herein. For example, in some embodiments, a slanted grating including a plurality of slanted ridges may be used as the grating coupler, where a height of the slanted ridges may be equal to or close to an integer multiple of the period of the slanted grating divided by the tangent of the slant angle of the slanted ridges. In one example, the height and slant angle of the slanted ridges of the slanted grating may be designed so that the height of the grating is equal to or close to the period of the slanted grating divided by the tangent of the slant angle of the slanted ridges. In other words, a top left (or right) point on a first ridge of the slanted grating may be vertically aligned with a bottom left (or right) point of a second ridge of the slanted grating. Thus, the slanted grating may be considered as including two overlapped slanted gratings with an offset of about a half of the grating period between the two slanted gratings. As a result, external light diffracted by the two offset slanted gratings (e.g., the −1st order diffraction) may be out of phase by about 180°, and thus may destructively interfere with each other such that most of the external light may enter the waveguide as the 0^{th} order diffraction, which may not be wavelength dependent. In this way, the rainbow ghost caused by the −1st order diffraction of external light by the grating coupler may be reduced or eliminated. Thus, the efficiency of the −1st order transmissive diffraction of the grating coupler for the external light can be much lower than that of the −1st order reflective diffraction of the grating coupler for the display light. For example, the efficiency for the −1st order diffraction of the display light may be greater than about 5%, about 20%, about 30%, about 50%, about 75%, about 90%, or higher, while the efficiency for the −1st order diffraction of the external light may be less than about 2%, less than about 1%, less than about 0.5%, or lower. In some implementations, an antireflection coating may be used to reduce the reflection of the external light at a surface of the waveguide or the grating coupler, where the external light, if reflected back to the grating coupler and then diffracted by the grating coupler, may cause rainbow ghosts and/or other artifacts.

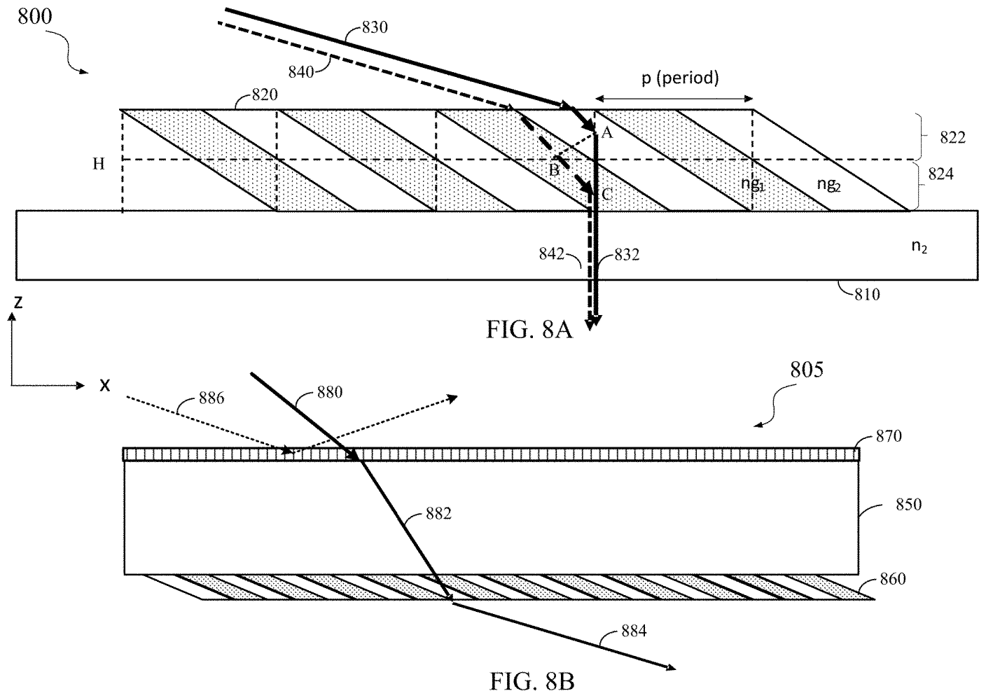

FIG. 8A is a simplified diagram illustrating external light diffraction (e.g., transmissive diffraction) by a grating coupler 820 in a waveguide display 800 with reduced rainbow artifacts according to certain embodiments. Waveguide display 800 may include a waveguide 810 and grating coupler 820 on one side of waveguide 810. Grating coupler 820 may be formed on a waveguide 810 (e.g., a transparent substrate with a refractive index n₂) of waveguide display 800. Grating coupler 820 may include a plurality of periods in the x (horizontal) direction. Each period may include a first slanted region formed of a material with a refractive index n_{g1}, and a second slanted region formed of a material with a refractive index n_{g2}. In various embodiments, the difference between n_{g1} and n_{g2} may be greater than 0.1, 0.2, 0.3, 0.5, 1.0, or higher. In some implementations, one of first slanted region and second slanted region may be an air gap with a refractive index of about 1.0. First slanted region and second slanted region may have a slant angle α with respect to the z (vertical) direction. The height (H) of first slanted region and second slanted region may be equal or close to (e.g., within about 5% or 10% of) an integer multiple (m) of the grating period p divided by the tangent of the slant angle α, i.e.,
H×tan(α)≅m×p.
   In the example shown in FIG. 8A, m is equal to 1. Thus, the top left point of a first slanted region in a grating period may align vertically with the bottom left point of another first slanted region in a different grating period. Grating coupler 820 may thus include a first (top) slanted grating 822 and a second (bottom) slanted grating 824 each having a height of H/2. First slanted grating 822 and a second slanted grating 824 may be offset from each other in the x direction by p/2. In other embodiments, m may be equal to or greater than 2. For example, grating coupler 820 may include four overlapped slanted gratings each having a height of H/4 and offset from each other by a half grating period (p/2) in the x direction.

External light (e.g., a plane wave) incident on grating coupler 820 may include a first portion (external light 830) and a second portion (external light 840) that may have the same phase. External light 830 may be refracted into grating coupler 820 and diffracted by first slanted grating 822 into a −1st order diffraction light 832, and external light 840 may be refracted into grating coupler 820 and diffracted by second slanted grating 824 into a −1st order diffraction light 842. Point A and point B may be in phase. Therefore, the phase difference between diffraction light 832 and diffraction light 842 may be approximated by:

$$2 π \frac{OP {L}_{A C} - OP {L}_{B C}}{{λ}_{0}} + Δ ,$$

where OPL_{AC} is the optical path length (physical length multiplied by the refractive index) between point A and point C, OPL_{BC} is the optical path length between point B and point C, λ₀ is the wavelength of the external light in free space, and Δ is the phase difference caused by the diffraction by first slanted grating 822 and the diffraction by second slanted grating 824. The difference between OPL_{AC} and OPL_{BC} may be fairly small, and thus the phase difference between diffraction light 832 and diffraction light 842 may be close to Δ.

The electrical field of the light diffracted by a grating may be determined using Fourier optics according to,

o(x)=g(x)⊗(x), or

O(f)=G(f)×I(f),

where I(f), G(f), and O(f) are the Fourier transforms of input field i(x), grating function g(x), and output field o(x), respectively, and, and ⊗ is the convolution operator. The Fourier transform of grating function g(x) for first slanted grating 822 may be:
F(g(x))=G(f).
   The Fourier transform of the grating function for second slanted grating 824 may be:

F(g(x−a))=e^{-i2πfa}G(f),

where a is the offset of second slanted grating 824 with respect to first slanted grating 822 in the x direction. Because the spatial frequency f of the grating is equal to 1/p, when a is equal top/2, e^{-i2πfa} becomes e^{-iπ}. As such, the electrical field of the light diffracted by first slanted grating 822 and the electrical field of the light diffracted by second slanted grating 824 may be out of phase by about 180° (or π). Therefore, Δ may be equal to about π. Because the optical path difference between OPL_{AC} and OPL_{BC} is fairly small,

$$2 π \frac{O P {L}_{A C} - O P {L}_{B C}}{{λ}_{0}} + Δ$$

may be close to π and thus may cause at least partial destructive interference between diffraction light 832 and diffraction light 842.

To further reduce the overall −1^{st} order diffraction of external light by grating coupler 820, it is desirable that the phase difference between diffraction light 832 and diffraction light 842 is about 180° (or π), such that diffraction light 832 and diffraction light 842 can destructively interfere to cancel each other. In some embodiments, the height, period, and/or slant angle of grating coupler 820 may be adjusted such that Δ may be different from π, but

$$2 π \frac{O P {L}_{A C} - O P {L}_{B C}}{{λ}_{0}} + Δ$$

may be approximately equal to π to cause destructive interference between diffraction light 832 and diffraction light 842.

Alternatively or additionally, an angular-selective transmissive layer may be placed in front of (and/or behind) the waveguide and the grating coupler of a waveguide-based near-eye display to further reduce the artifacts caused by external light source. The angular-selective transmissive layer may be configured to reflect, diffract, or absorb ambient light with an incident angle greater than one half of the see-through field of view of the near-eye display, while allowing ambient light within the see-through field of view of the near-eye display to pass through and reach user's eyes with little or no loss. The angular-selective transmissive layer may include, for example, a coating that may include one or more dielectric layers, diffractive elements such as gratings (e.g., meta-gratings), nanostructures (e.g., nanowires, nano-prisms, nano-pyramids), and the like.

FIG. 8B illustrates an example of a waveguide display 805 including an angular-selective transmissive layer 870 according to certain embodiments. Waveguide display 805 may be similar to waveguide display 650 described above. For example, waveguide display 805 may include a waveguide 850 and a grating coupler 860 at the bottom surface of waveguide 850. Grating coupler 860 may be similar to grating couplers 520, 620, 670, and 820 described above. External light 880 incident on waveguide 850 with incident angle less than a certain threshold value (e.g., about 50°) may be refracted into waveguide 850 as external light 882 and may then reach grating coupler 860. The diffracted light may include a 0^{th} order diffraction 884 (i.e., refractive diffraction) and a −1st order diffraction (not shown). As described above with respect to, for example, FIG. 8A, the height, period, and slant angle of grating coupler 860 may be configured such that the −1st order diffraction may be reduced or minimized. Thus, external light 882 may be refracted by grating coupler 860 as a light beam 884, which may be the 0^{th} order diffraction.

Angular-selective transmissive layer 870 may be coated on the top surface of waveguide 850. Angular-selective transmissive layer 870 may absorb, reflect, or diffract (in certain directions such that the diffracted light would not reach user's eyes) incident light with an incident angle greater than the certain threshold value, and may have a low loss for incident light with an incident angle lower than the threshold value. The threshold value may be determined based on the see-through field of view of waveguide display 805. For example, incident light 886 with an incident angle greater than a half of the see-through field of view may be mostly reflected, diffracted, or absorbed by angular-selective transmissive layer 870, and thus may not enter waveguide 850. External light 880 with an incident angle within the see-through field of view may mostly pass through angular-selective transmissive layer and waveguide 850, and may be refracted by grating coupler 860 as described above.

In some embodiments, angular-selective transmissive layer 870 may include a plurality of absorptive or reflective layers arranged in a stack, a layer of subwavelength structures, a grating layer with a subwavelength grating period (e.g., configured to diffract ambient light having a large incident angle out of the eyebox, such as meta-gratings), a microlouver layer, nanostructures (e.g., nanowires, nano-prisms, nano-pyramids), or the like. Angular-selective transmissive layer 870 may include, for example, glass or other oxides (e.g., ZnO), polycarbonate, polymers or other plastic (e.g., polyester). In some embodiments, the waveguide display may be characterized by a see-through field of view, and the threshold value may be equal to or greater than a half of the see-through field of view. In some embodiments, the threshold value is greater than 60°. In some embodiments, a reflectivity, diffraction efficiency, or absorptivity of the angular-selective transmissive layer for ambient light with the incidence angle greater than the threshold value may be greater than about 90%.

In some embodiments, ambient light entered the waveguide (e.g., refracted by grating coupler 820 into waveguide 810 or transmitted through angular-selective transmissive layer 870 into waveguide 850) may be reflected by other surfaces between two media of different refractive indices in a waveguide display system, such as the bottom surface of waveguide 810 or the bottom surface of grating coupler 860. The reflected light may reach a grating coupler from a certain direction, and may be diffracted by the grating coupler to cause optical artifacts, such as rainbow images.

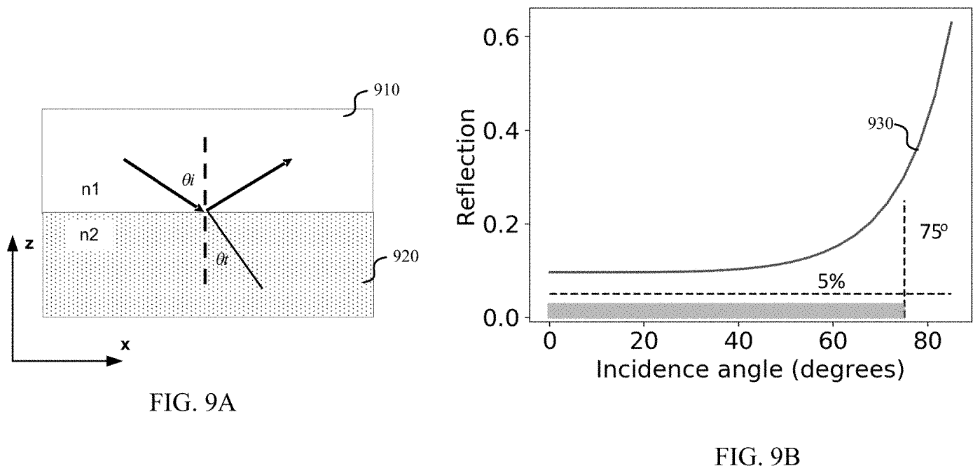

FIG. 9A illustrates light reflection at an interface between two adjacent layers 910 and 920 having different refractive indices n₁ and n₂, respectively. Light reflection may occur at the interface between two materials having different refractive indices, where the reflectivity may be a function of the incident angle and the refractive indices of the two adjacent layers as indicated by Fresnel equations:

$${R}_{s} = {\vert \frac{{n}_{1} cos {θ}_{i} - {n}_{2} cos {θ}_{t}}{{n}_{1} cos {θ}_{i} + {n}_{2} cos {θ}_{t}} \vert}^{2} = {\vert \frac{{n}_{1} cos {θ}_{i} - {n}_{2} \sqrt{1 - {( \frac{{n}_{1}}{{n}_{2}} sin {θ}_{i} )}^{2}}}{{n}_{1} cos {θ}_{i} + {n}_{2} \sqrt{1 - {( \frac{{n}_{1}}{{n}_{2}} sin {θ}_{i} )}^{2}}} \vert}^{2} , \\ and$$

$${R}_{p} = {\vert \frac{{n}_{1} cos {θ}_{t} - {n}_{2} cos {θ}_{i}}{{n}_{1} cos {θ}_{t} + {n}_{2} cos {θ}_{i}} \vert}^{2} = {\vert \frac{{n}_{1} \sqrt{1 - {( \frac{{n}_{1}}{{n}_{2}} sin {θ}_{i} )}^{2}} - {n}_{2} cos {θ}_{i}}{{n}_{1} \sqrt{1 - {( \frac{{n}_{1}}{{n}_{2}} sin {θ}_{i} )}^{2}} + {n}_{2} cos {θ}_{i}} \vert}^{2} .$$

Rₛ and Rₚ are the reflectivity for s-polarized light and p-polarized light, respectively, as a function of incident angle θᵢ. n₁ and n₂ are the refractive indexes of adjacent dielectric layers. θₜ is the refraction angle.

FIG. 9B illustrates light reflectivity at the interface between the two adjacent layers 910 and 920 as a function of the incident angle for red light (e.g., with a wavelength about 600 nm). For example, layer 910 may be the air and may have a refractive index 1.0, and layer 920 may be a dielectric substrate, such as a glass substrate with a refractive index about 1.9. As illustrated by a curve 930, the reflectivity may be about 10% for light with incident angles less than about 40° and may increase gradually with the incident angle. The reflectivity may have a larger slope with respect to the increase in incident angle at a large incident angle, such as 60° or larger. For example, the reflectivity may be greater than about 20% for light with incident angles larger than about 70°.

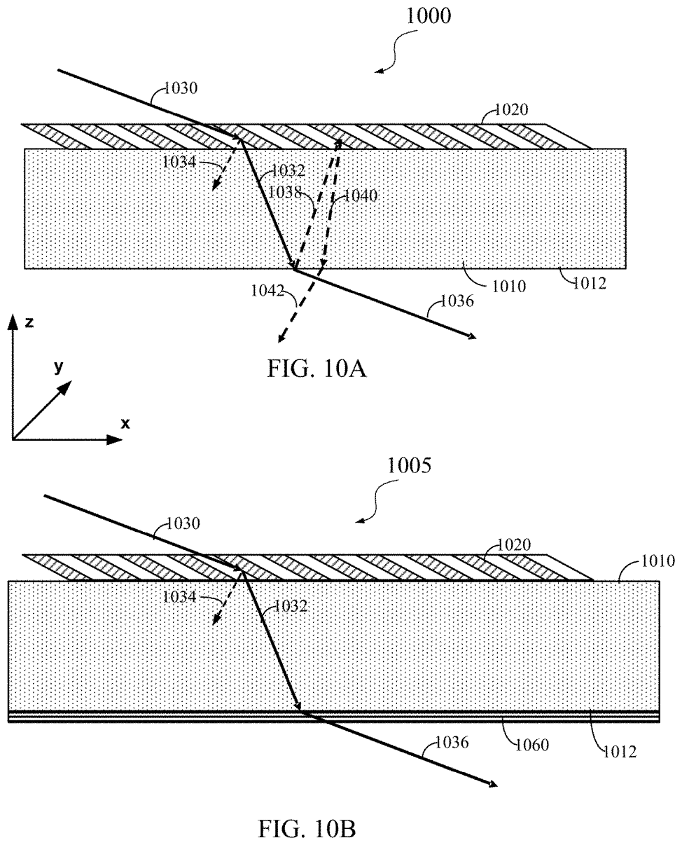

FIG. 10A illustrates rainbow artifacts caused by light reflection at a surface of a waveguide display 1000 according to certain embodiments. Waveguide display 1000 may include a waveguide 1010 and a grating coupler 1020 at the top surface of waveguide 1010. Grating coupler 1020 may be similar to grating couplers 820 and 860 described above. External light incident on grating coupler 1020 may be diffracted (and/or refracted) by grating coupler 1020 into waveguide 1010. The diffracted light may include a 0^{th} order diffraction 1032 (or refraction) and a −1st order diffraction 1034. 0^{th} order diffraction 1032 may be refracted out of waveguide 1010 as light 1036. As described above, the height, period, and slant angle of grating coupler 1020 may be configured such that −1st order diffraction 1034 may be significantly reduced or minimized.

However, 0^{th} order diffraction 1032 may be reflected at a bottom surface 1012 of waveguide 1010. Light 1038 reflected at bottom surface 1012 may reach grating coupler 1020 again. As described above with respect to, for example, display light 540 shown in FIG. 5, light 1038 may be reflectively diffracted by grating coupler 1020. The −1^{st} order diffraction of the reflective diffraction of light 1038 by grating coupler 1020 may not be reduced or minimized even though grating coupler 1020 may be configured to reduce or minimize the −1^{st} order diffraction of the transmissive diffraction. Thus, −1^{st} order diffraction 1040 from reflected light 1038 may reach bottom surface 1012 and may be refracted out of waveguide 1010 as light 1042 that may reach user's eye and appear as a rainbow ghost. Thus, waveguide display 1000 may still cause relatively strong rainbow ghost images.

In one example, ambient light 1030 may be transmitted into waveguide 1010 with a transmissivity of about 70% (e.g., due to reflection at the top surface of grating coupler 1020). 30% of the 0^{th} order diffraction 1032 may be reflected at bottom surface 1012 of waveguide 1010. 5% of the reflected light 1038 may be reflectively diffracted by grating coupler 1020 as −1^{st} order diffraction 1040, 80% of which may be transmitted out of waveguide 1010 as light 1042 due to, for example, additional reflection at bottom surface 1012. Thus, the total efficiency of ambient light directed towards user's eye may be about 0.7×0.3×0.05×0.8≈1%. When the ambient light, for example, light from a light source, such as the sun or a lamp, has a high intensity, the ghost images may have a relatively high intensity with respect to the display images.

According to certain embodiments, to reduce the ghost images caused by the reflective diffraction of ambient light reflected at the interface between two layers of different refractive indices, a display system may include a substrate, a grating on one surface of the substrate, and an antireflection layer on the opposite surface of the substrate. The antireflection layer may be used to reduce the reflection of ambient light at the interface between the substrate and air, and thus the reflective diffraction of the reflected ambient light. For example, if the reflectivity of ambient light at bottom surface 1012 of waveguide 1010 is reduced from 30% to 5% or lower, the total efficiency of ambient light with a large incident angle and directed towards user's eye may be reduced from about 1% to less than about 0.2%. In some embodiments, a second antireflection layer may be formed on the grating. In some embodiments, the display system may include two or more substrates, where at least one of the two or more substrates may include antireflection layers on two opposite surfaces of the substrate. For example, one antireflection layer may be on a grating formed on the substrate.

FIG. 10B illustrates an example of a waveguide display 1005 having an antireflection layer 1060 for reducing rainbow artifacts caused by light reflection at bottom surface 1012 of waveguide 1010 according to certain embodiments. Waveguide display 1005 may be similar to waveguide display 1000. Waveguide display 1005 may include an additional antireflection layer 1060 on bottom surface 1012 of waveguide 1010. Antireflection layer 1060 may include, for example, one or more dielectric thin film layers coated on bottom surface 1012, a nano-structured coating, or any other antireflection structures for reducing the reflection of visible light. Antireflection layer 1060 may be used to reduce the reflection of ambient light at bottom surface 1012. Thus, little or no light may be reflected at bottom surface 1012 of waveguide 1010 back to grating coupler 1020, and therefore the rainbow ghost that might otherwise be formed due to the reflection of external light at bottom surface 1012 and the reflective diffraction by grating coupler 1020 as described above with respect to FIG. 10A may be reduced or minimized.

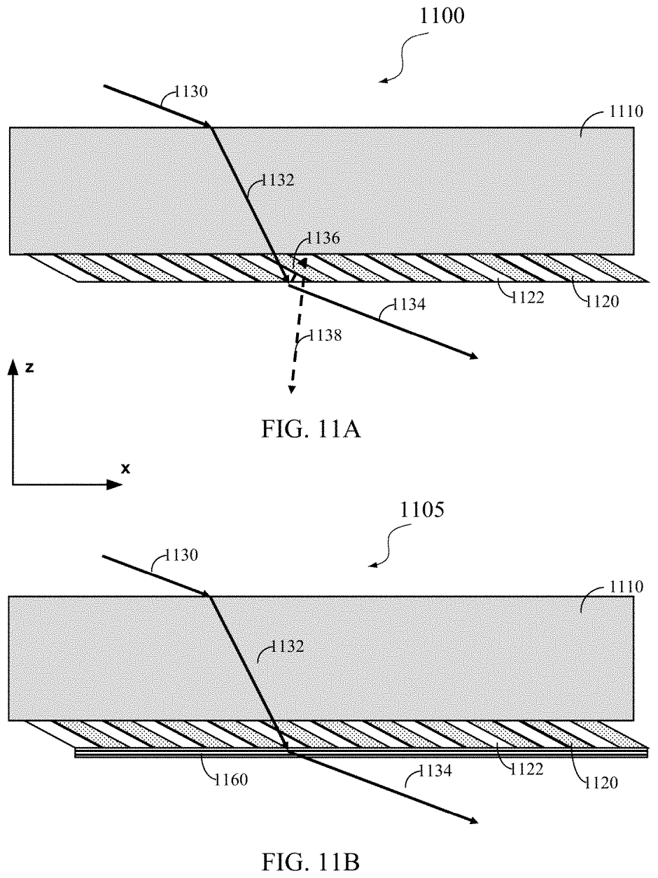

FIG. 11A illustrates rainbow artifacts caused by light reflection at a surface of a grating coupler 1120 of an example of a waveguide display 1100 according to certain embodiments. Waveguide display 1100 may include a waveguide 1110 (e.g., a transparent substrate) and a grating coupler 1120 at the bottom surface of waveguide 1110. Grating coupler 1120 may be similar to grating coupler 860 described above. External light 1130 incident on waveguide 1110 may be refracted into waveguide 1110 as external light 1132 and may then be diffracted by grating coupler 1120. The diffracted light may include a 0^{th} order diffraction 1134 and a −1st order diffraction (not shown). As described above, the height, period, and slant angle of grating coupler 1120 may be configured such that the −1st order diffraction may be reduced or minimized.

External light 1132 may be reflected at a bottom surface 1122 of grating coupler 1120. Light 1136 reflected at bottom surface 1122 of grating coupler 1120 may be reflectively diffracted by grating coupler 1120. As described above with respect to FIG. 10A, the −1^{st} order diffraction of the reflective diffraction by grating coupler 1120 may not be reduced or minimized by a grating coupler that may be configured to reduce or minimize the −1^{st} order diffraction of the transmissive diffraction. Thus, the −1^{st} order reflective diffraction 1138 from reflected light 1136 may reach the user's eye and thus may appear as a rainbow ghost to the user. Therefore, waveguide display 1100 may still cause relatively strong rainbow ghost images.

FIG. 11B illustrates an example of a waveguide display 1105 having an antireflection layer 1160 for reducing rainbow artifacts caused by light reflection at bottom surface 1122 of grating coupler 1120 of waveguide display 1105 according to certain embodiments. Waveguide display 1105 may be similar to waveguide display 1100, and may include additional antireflection layer 1160 on bottom surface 1122 of grating coupler 1120. Antireflection layer 1160 may include one or more dielectric thin film layers or nanostructures coated on bottom surface 1122, and may be used to reduce the reflection of the external light at bottom surface 1122. Thus, little or no external light may be reflected at bottom surface 1122 of grating coupler 1120 back to grating coupler 1120, and therefore the rainbow ghost that might otherwise be formed due to the reflection of external light at bottom surface 1122 and the reflective diffraction by grating coupler 1120 as described above with respect to FIG. 11A may be reduced or minimized.

For display light propagating within waveguide 1110, at least a portion of the display light may be reflected at the interface between waveguide 1110 and grating coupler 1120 due to total internal reflection and/or reflective diffraction by grating coupler 1120, and thus may not reach antireflection layer 1160. Some portions of the display light may be diffracted by grating coupler 1120 and may be coupled out of waveguide 1110 towards user's eyes (e.g., due to −1^{st} order diffraction). Antireflection layer 1160 may also help to reduce the reflection of the portions of the display light that are coupled out of waveguide 1110 by grating coupler 1120 at bottom surface 1122 of grating coupler 1120.

The antireflection layers, such as antireflection layers 1060 and 1160, may need to reduce both the see-through reflection and the reflection of the display light. The antireflection layers may also need to reduce reflection for light within broad wavelength and angular ranges, such as all visible display light and ambient light with grazing angles from about 0° to about 90°. It is also desirable that the antireflection layer would not result in see-through haze or degrade the display contrast. For example, the antireflection layer may need to work for wavelengths between about 450 nm and about 600 nm, and may have low reflection (e.g., below about 5% or 3%) for ambient light with incidence angles within 0-60 degrees (for see-through quality) and low reflection (e.g., below about 5% or 3%) for ambient light with incidence angles within about 60° to about 75° or larger (for rainbow reduction). The antireflection layer may include uniform layers of different materials or periodic structures. When the antireflection layer includes periodic structures, the periods of the periodic structures may be small (e.g., less than a half of the period of the grating coupler) to have a large diffraction angle such that the antireflection layer may not affect the quality of the displayed images, such as reducing the contrast of the displayed images, and may not affect the quality of the see-through images, such as causing haze in the see-through images.

In some embodiments, the antireflection layer may be implemented using two or more layers of different materials with different refractive indices, where one or more of the two or more layers may be a layer with a low refractive index, such as close to 1. In some embodiments, the layer with the low refractive index may be achieved using one-dimensional or two-dimensional periodic structures with low filling factors or small duty cycles.

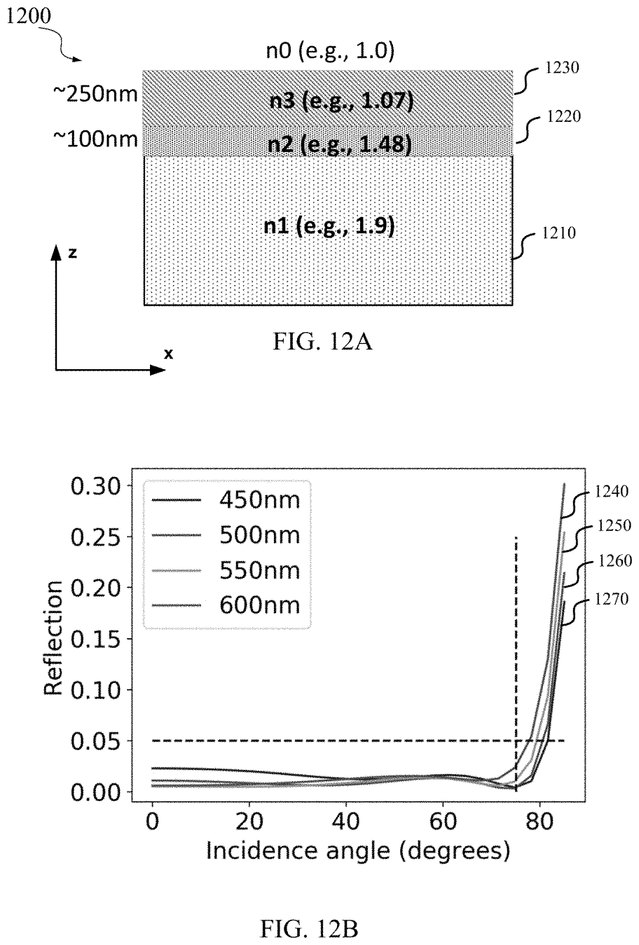

FIG. 12A illustrates an example of an antireflection structure 1200 according to certain embodiments. Antireflection structure 1200 may include a substrate 1210 that may have a higher refractive index. Substrate 1210 may be transparent to visible light, infrared light, or both. Substrate 1210 may include, for example, glass, quartz, polymer, or the like. In the example shown in FIG. 12A, substrate 1210 may be a glass substrate with a refractive index n₁, for example, about 1.9.

A first transparent material layer 1220 may be coated on substrate 1210 and a second transparent material layer 1230 may be coated on first transparent material layer 1220. Second transparent material layer 1230 may be exposed to, for example, air (with a refractive index no about 1.0). First transparent material layer 1220 may have a refractive index lower than the refractive index of substrate 1210 but higher than the refractive index of second transparent material layer 1230. First transparent material layer 1220 and second transparent material layer 1230 may include, for example, a dielectric or polymer material. In the example shown in FIG. 12A, first transparent material layer 1220 may have a refractive index n₂ about 1.48 and a thickness about 100 nm, and second transparent material layer 1230 may have a refractive index n₃ about 1.07 and a thickness about 250 nm.

FIG. 12B illustrates reflectivity of the example of antireflection structure 1200 shown in FIG. 12A as a function of the incident angle for light of different colors. For example, curves 1240, 1250, 1260, and 1270 in FIG. 12B may represent the reflectivity of red light (e.g., with a wavelength about 600 nm), orange/amber light (e.g., with a wavelength about 550 nm), green light (e.g., with a wavelength about 500 nm), and blue light (e.g., with a wavelength about 450 nm), respectively. Curves 1240-1270 show that the reflectivity may be less than about 3% for all visible light with incident angles less than about 75° and may increase rapidly with the incident angle when the incident angle is greater than about 75°. As such, the total efficiency of ambient light directed towards user's eye may be less than about 0.2%, less than about 0.1%, or lower as described above with respect to FIG. 10A.

Antireflection structure 1200 shown in FIG. 12A, in particular, second transparent material layer 1230, may be difficult to achieve using a uniform layer of materials due to, for example, the low refractive index of second transparent material layer 1230. According to certain embodiments, the low refractive index of second transparent material layer 1230 in antireflection structure 1200 may be achieved using one-dimensional or two-dimensional periodic structures with a small duty cycle or fill factor.

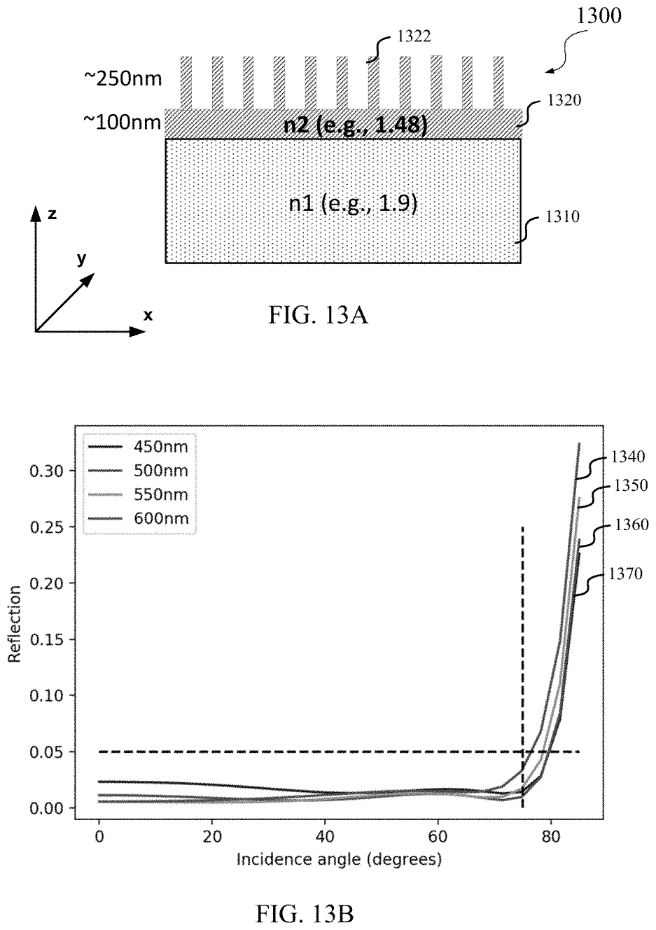

FIG. 13A illustrates an example of an antireflection structure 1300 according to certain embodiments. Antireflection structure 1300 may be an example of antireflection structure 1200. Antireflection structure 1300 may include a substrate 1310 that may be similar to substrate 1210 and may have a refractive index n1, for example, about 1.9. A transparent material layer 1320 may be coated on substrate 1310, and a periodic structure 1322 may be formed in transparent material layer 1320. The material in transparent material layer 1320 may be, for example, a polymer layer, and may have a refractive index n₂, for example, about 1.4. Periodic structure 1322 may be formed in transparent material layer 1320 using, for example, photolithography or nanoimprinting. Periodic structure 1322 may have a period less than, for example, about one half of the period of the grating coupler used for coupling light into or out of waveguides, such as grating couplers 820, 860, 1020, or 1120. The smaller period may help to reduce the effect of periodic structure 1322 on display light (e.g., contrast of the displayed image) and reduce see-through haze.

In the example shown in FIG. 13A, transparent material layer 1320 may have a total thickness about 350 nm, and the height of period structure 1322 may be about 250 nm. Periodic structure 1322 may correspond to second transparent material layer 1230 of FIG. 12A. The effective refractive index n_{eff} of periodic structure 1322 may be determined by:

n_{eff}=n₂*f+nₐᵢᵣ*(1−f),

where n₂ is the refractive index of the material in transparent material layer 1320, nₐᵢᵣ is the refractive index of air (about 1.0), and f is the duty cycle or fill factor. For example, to achieve an effective refractive index similar to refractive index n₃ (e.g., about 1.07) of second transparent material layer 1230 using a material with refractive index n₂ (e.g., about 1.48), the fill factor may be about 14.5%. In the example shown in FIG. 13A, periodic structure 1322 may be a one-dimensional periodic structure, such as a one-dimensional rectangular wave grating with a pitch about 175 nm and a width of each grating ridge about 24 nm, such that the duty cycle or fill factor of periodic structure 1322 may be about 24/175≈14%.

FIG. 13B illustrates reflectivity of the example of antireflection structure 1300 shown in FIG. 13A as a function of the incident angle for visible light. For example, curves 1340, 1350, 1360, and 1370 in FIG. 13B may represent the reflectivity of red light (e.g., with a wavelength about 600 nm), orange/amber light (e.g., with a wavelength about 550 nm), green light (e.g., with a wavelength about 500 nm), and blue light (e.g., with a wavelength about 450 nm), respectively. Curves 1340-1370 show that the reflectivity may be less than about 3% for all visible light with incident angles less than about 75° and may increase rapidly with the incident angle when the incident angle is greater than about 75°. As such, the total efficiency of ambient light directed towards user's eye may be less than about 0.2%, less than about 0.1%, or lower as described above.

In some embodiments, periodic structure 1322 may include a two-dimensional periodic structure, such as a two-dimensional array of pillars. In one example, the material used to make the pillars may have a refractive index 1.48, the two-dimensional array of pillars may have a pitch about 175 nm, and each pillar may have a diameter about 77 nm. Thus, the fill factor of periodic structure 1322 may be about

$$\frac{{π ( \frac{77}{2} )}^{2}}{17 {5}^{2}} \approx 15 \% ,$$

and the effective refractive index of periodic structure 1322 may be about 1.07. The two-dimensional array of pillars may be used as second transparent material layer 1230 to achieve similar reflectivity performance as the one-dimensional rectangular wave grating shown in FIGS. 13A and 13B, such as less than about 3% for all visible light with incident angles less than about 75°. In addition, to achieve the same effective refractive index, the periodic structures (e.g., pillars) in the two-dimensional periodic structure may have smaller aspect ratios (e.g., height/diameter) than the periodic structures (e.g., ridges) in the one-dimensional periodic structure. For example, in the examples described above, the width of each ridge in the one-dimensional periodic structure is about 24 nm and the aspect ratio of each ridge may be greater than 10:1, while in the two-dimensional structure, the diameter of each pillar is about 77 nm and the aspect ratio may be about 3:1.

In some embodiments, the antireflection structure may include multiple coating layers with a refractive index gradient. In some embodiments, the multiple coating layers with the refractive index gradient may be achieved using one-dimensional or two-dimensional periodic structures with tapered cross-sectional dimensions, such as prisms or cones, such that the filling factor and the effective refractive index of the periodic structures may gradually reduce.

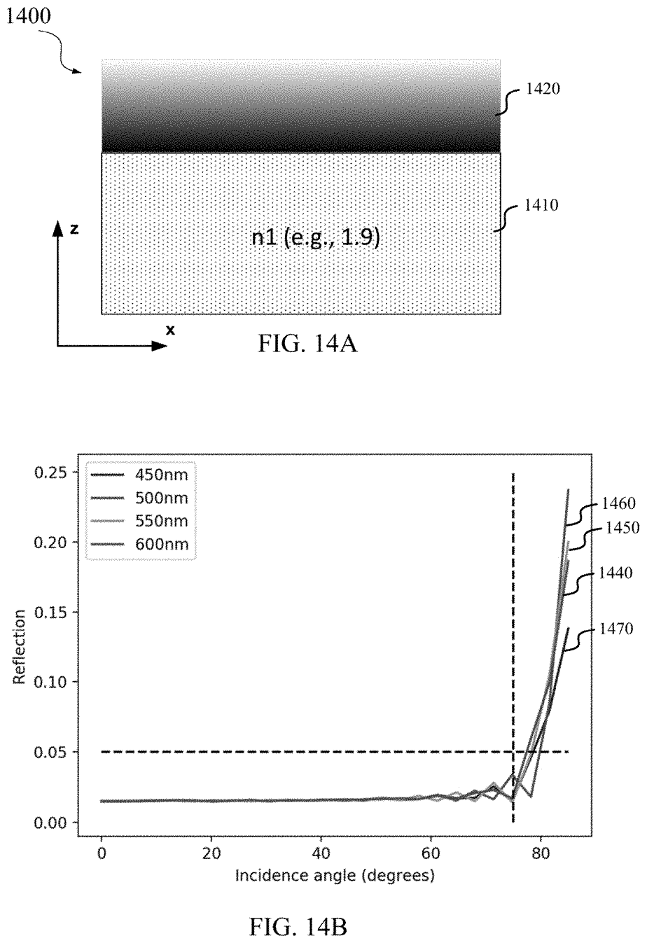

FIG. 14A illustrates an example of an antireflection structure 1400 according to certain embodiments. Antireflection structure 1400 may include a substrate 1410 that may be similar to substrate 1210 or 1310 and may have a refractive index n1, for example, about 1.9. Antireflection structure 1400 may also include a multi-layer structure 1420 formed on substrate 1410. Multi-layer structure 1420 may have a refractive index that may gradually reduce from the interface with substrate 1410 to the interface with air. In the example shown in FIG. 14A, multi-layer structure 1420 may include about 100 layers each having a different respective refractive index and arranged such that the refractive index of multi-layer structure 1420 may gradually reduce from about 1.48 to about 1.0 in the z direction. Because light reflection at the interface between different media is caused by the refractive index mismatch between different materials, gradually increasing the refractive index in multi-layer structure 1420 from air to substrate 1410 may significantly reduce or minimize the refractive index mismatches at the interfaces between adjacent material layers, thus reducing or minimizing the overall reflection.

FIG. 14B illustrates reflectivity of the example of the antireflection structure shown in FIG. 14A as a function of the light incident angle for visible light. For example, curves 1440, 1450, 1460, and 1470 in FIG. 14B may show the reflectivity of red light (e.g., with a wavelength about 600 nm), orange/amber light (e.g., with a wavelength about 550 nm), green light (e.g., with a wavelength about 500 nm), and blue light (e.g., with a wavelength about 450 nm), respectively. Curves 1440-1470 show that the reflectivity may be less than about 3% for all visible light with incident angles less than about 75° and may increase rapidly with the incident angle when the incident angle is greater than about 75°. As such, the total efficiency of ambient light directed towards user's eye may be less than about 0.2%, less than about 0.1%, or lower as described above.

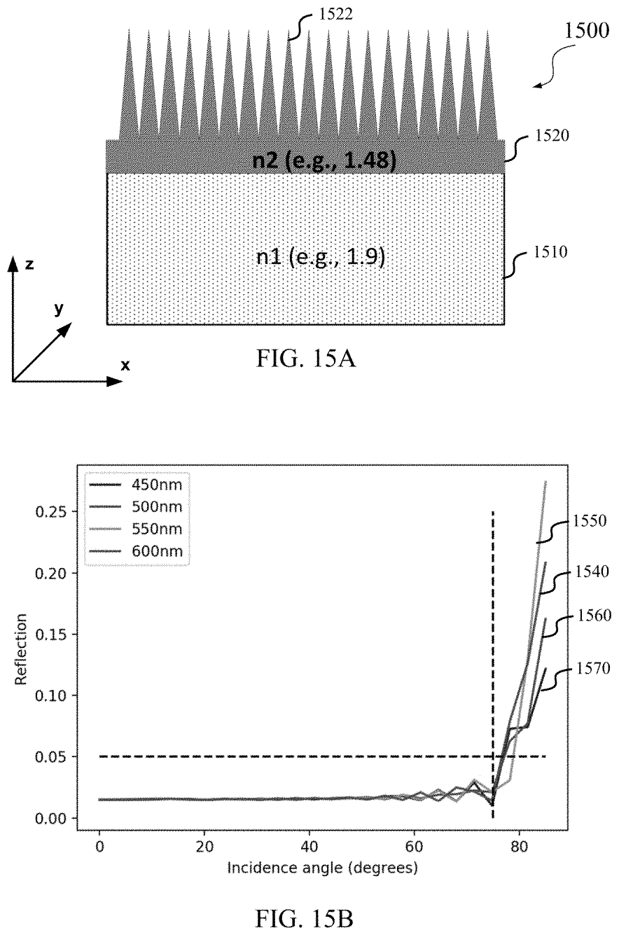

FIG. 15A illustrates an example of an antireflection structure 1500 according to certain embodiments. It may be time-consuming and/or difficult to implement multi-layer structure 1420 using multiple uniform layers including materials having different refractive indices, such as from about 1.48 to about 1.0. In some embodiments as shown in FIG. 15A, the multi-layer structure with the refractive index gradient may be achieved using one-dimensional periodic structures with tapered cross-section dimensions, such as tapers ridges or prisms.

Antireflection structure 1500 may include a substrate 1510 that may be similar to substrate 1210, 1310, or 1410, and may have a refractive index n₁, for example, about 1.9. A transparent material layer 1520 may be coated on substrate 1510, and a periodic structure 1522 may be formed in transparent material layer 1520. The material in transparent material layer 1520 may be, for example, a polymer layer, and may have a refractive index n₂, for example, about 1.48. Periodic structure 1522 may be formed in transparent material layer 1520 using, for example, photolithography, nanoimprinting, or other nanofabrication techniques. Periodic structure 1522 may have a period less than, for example, about one half of the period of the grating coupler used for coupling light into or out of waveguides, such as grating couplers 820, 860, 1020, or 1120. The smaller period may help to reduce the effect of periodic structure 1522 on display light (e.g., contrast of the displayed image) and reduce see-through haze as described above.

In the example shown in FIG. 15A, periodic structure 1522 may include a one-dimensional array of tapered ridges arranged in the x direction, where each ridge may extend in they direction. The period may be about 175 nm. The width of each ridge may gradually (e.g., linearly) reduce in the z direction, such that the fill factor and thus the effective refractive index as described above with respect to FIG. 13A may gradually reduce as well.

FIG. 15B illustrates reflectivity of the example of antireflection structure 1500 shown in FIG. 15A as a function of the incident angle for visible light of different colors. For example, curves 1540, 1550, 1560, and 1570 in FIG. 15B may show the reflectivity of red light (e.g., with a wavelength about 600 nm), orange/amber light (e.g., with a wavelength about 550 nm), green light (e.g., with a wavelength about 500 nm), and blue light (e.g., with a wavelength about 450 nm), respectively. Curves 1540-1570 show that the reflectivity may be less than about 3% for all visible light with incident angles less than about 75° and may increase rapidly with the incident angle when the incident angle is greater than about 75°. As such, the total efficiency of ambient light directed towards user's eye may be less than about 0.2%, less than about 0.1%, or lower as described above.

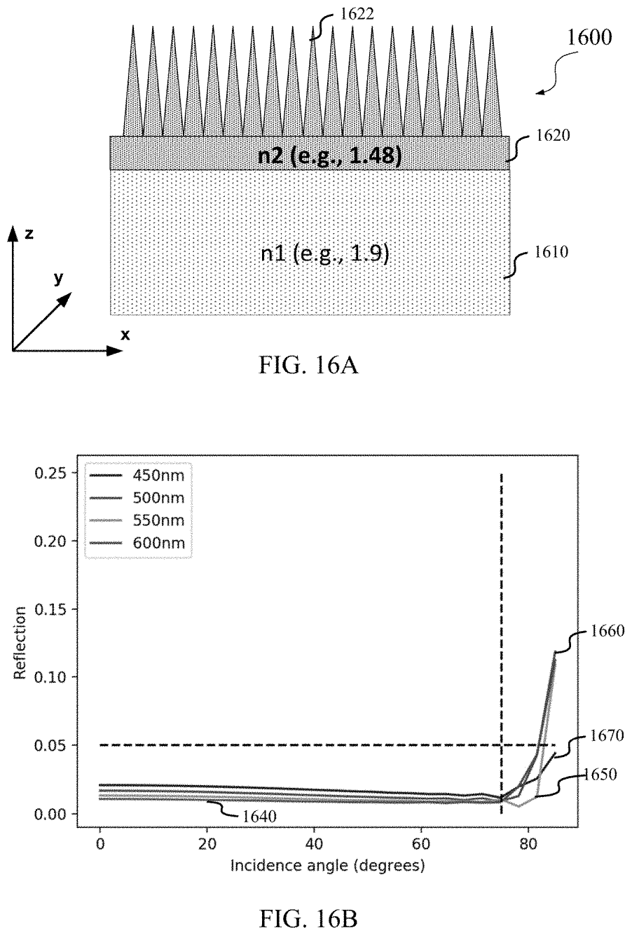

FIG. 16A illustrates an example of an antireflection structure 1600 according to certain embodiments. Antireflection structure 1600 may include a substrate 1610 that may be similar to substrate 1210, 1310, 1410, or 1510, and may have a refractive index n₁, for example, about 1.9. A transparent material layer 1620 may be coated on substrate 1610, and a periodic structure 1622 may be formed in transparent material layer 1620. The material in transparent material layer 1620 may be, for example, a polymer layer, and may have a refractive index n₂, for example, about 1.48. Periodic structure 1622 may be formed in transparent material layer 1620 using, for example, photolithography, nanoimprinting, or other nanofabrication techniques. Periodic structure 1622 may include a two-dimensional array of tapered ridges, prisms, or cones, and may have periods less than, for example, about one half of the period of the grating coupler used for coupling light into or out of waveguides, such as grating couplers 820, 860, 1020, or 1120. The smaller period may help to reduce the diffractive effects of periodic structure 1622 on display light (e.g., contrast of the displayed image), while the periodicity of periodic structure 1622 may eliminate the see-through haze of periodic structure 1622 as described above.

In the example shown in FIG. 16A, periodic structure 1622 may include a two-dimensional array of micro-cones, where the period may be about 175 nm in x and y directions. The width of each ridge may gradually (e.g., linearly) reduce in the z direction, such that the fill factor and thus the effective refractive index as described above with respect to FIG. 13A may gradually reduce as well.

FIG. 16B illustrates reflectivity of the example of antireflection structure 1600 shown in FIG. 16A as a function of the incident angle for visible light of different colors. For example, curves 1640, 1650, 1660, and 1670 in FIG. 16B may show the reflectivity of red light (e.g., with a wavelength about 600 nm), orange/amber light (e.g., with a wavelength about 550 nm), green light (e.g., with a wavelength about 500 nm), and blue light (e.g., with a wavelength about 450 nm), respectively. Curves 1640-1670 show that the reflectivity may be less than about 3% for all visible light with incident angles less than about 75° and may increase rapidly with the incident angle when the incident angle is greater than about 75°. As such, the total efficiency of ambient light directed towards user's eye may be less than about 0.2%, less than about 0.1%, or lower.

In some embodiments, a waveguide display system may include multiple substrates and/or grating layers, for example, for light of different colors, for different fields of view, or for displaying images and tracking eye movement. Thus, if the antireflection structures described above are on only one surface of a substrate or on only some substrates, there might be ambient light reflection at the interface between two media of different refractive indices and/or by reflective diffraction of gratings in the near-eye display system to reach user's eyes. In addition, ambient light may be from different sides of the near-eye display system. Thus, ambient light may still reach the diffraction grating and be diffracted by the diffraction grating to reach user's eye and cause optical artifacts.

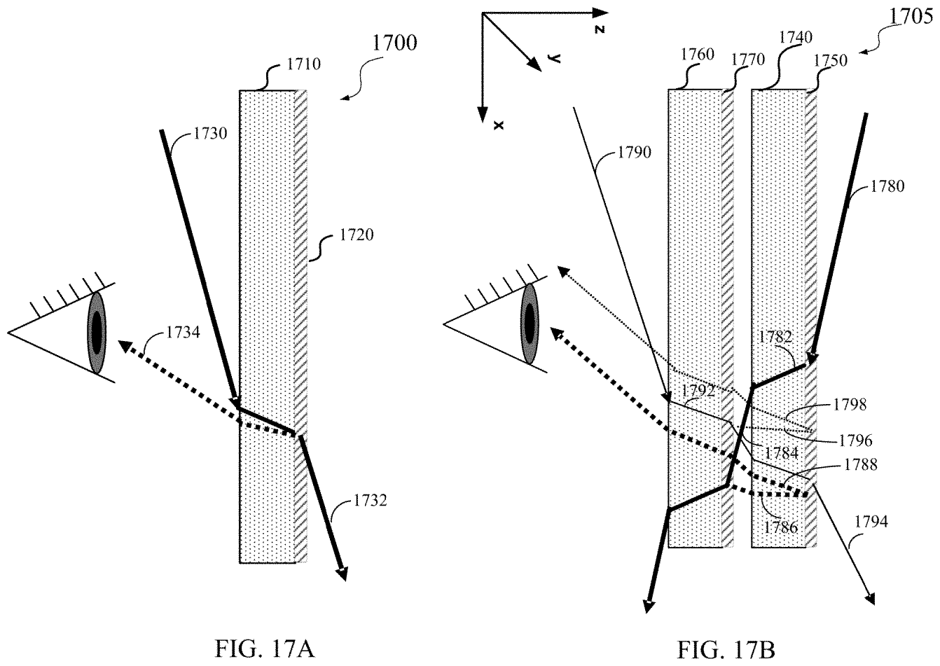

FIG. 17A illustrates optical artifacts caused by reflective diffraction of ambient light from the back side of an example of a waveguide display 1700. Waveguide display 1700 may include a waveguide 1710 and a layer 1720, which may include a grating coupler and/or angular-selective transmissive layer (e.g., angular-selective transmissive layer 870) as described above. As illustrated, ambient light 1730 may reach waveguide display 1700 from the user side. A portion 1732 of ambient light 1730 may be transmitted through layer 1720, while another portion 1734 of ambient light 1730 may be reflected or reflectively diffracted by layer 1720 and reach user's eye to cause optical artifacts, such as rainbow images.

FIG. 17B illustrates optical artifacts in an example of a waveguide display 1705 that includes two or more substrates. In the illustrated example, waveguide display 1705 may include a first substrate 1740 and a second substrate 1760. First substrate 1740 may include a first layer 1750, which may include a grating coupler as described above. Similarly, second substrate 1760 may include a second layer 1770, which may include a grating coupler as described above.

Ambient light 1780 may enter first substrate 1740 as a refracted light beam 1782, which may be transmitted through first substrate 1740 and reach second layer 1770 as a light beam 1784. Light beam 1784 may be partially reflected or reflectively diffracted by second layer 1770 and return back into first substrate 1740 as a light beam 1786. Light beam 1786 may be partially reflectively diffracted by first layer 1750 as a light beam 1788, which may eventually reach user's eye to cause optical artifacts.

Ambient light 1790 may enter second substrate 1760 from the user side and may be transmitted through second substrate 1760 and reach second layer 1770 as a light beam 1792. A portion of light beam 1792 may be transmitted through second layer 1770, first substrate 1740, and first layer 1750 and out of waveguide display 1705 as a light beam 1794. Another portion of light beam 1792 may be transmissively diffracted by second layer 1770 and enter first substrate 1740 as a light beam 1796. Light beam 1796 may be partially reflectively diffracted by first layer 1750 as a light beam 1798, which may eventually reach user's eye to cause optical artifacts.

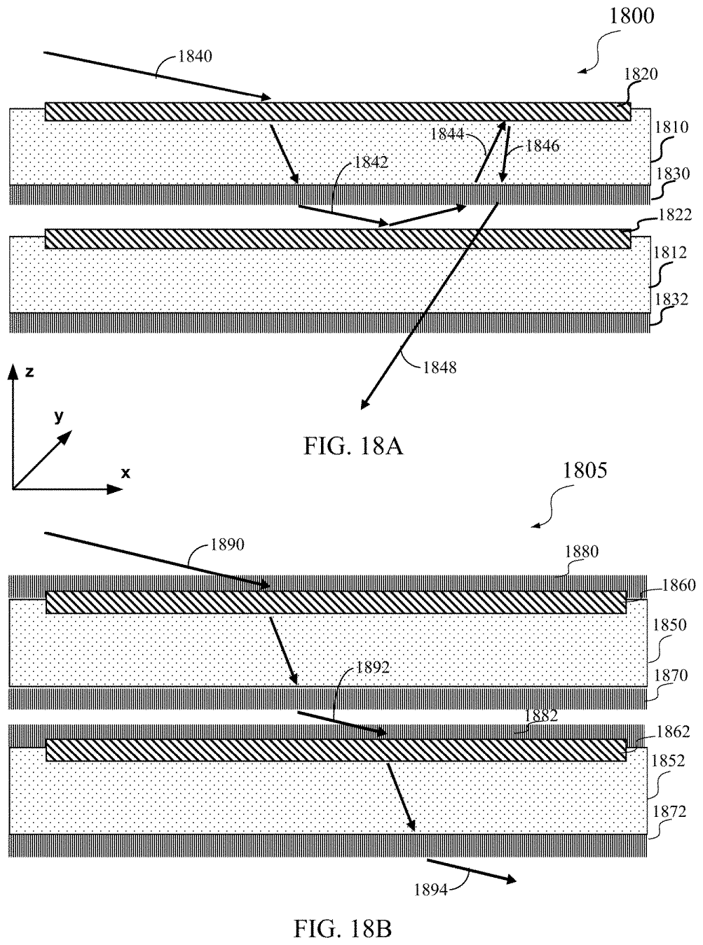

FIG. 18A illustrates rainbow artifacts caused by light reflection at a surface of a substrate and reflective diffraction by a grating in an example of a waveguide display 1800 that includes two or more substrates. In the illustrated example, waveguide display 1800 may include a first substrate 1810 and a second substrate 1812. First substrate 1810 may include a grating 1820 formed thereon, which may be designed to transmit ambient light, including ambient light 1840 from an angle outside of the see-through field of view of waveguide display 1800. First substrate 1810 may include an antireflection layer 1830 formed on the bottom surface of first substrate 1810 to reduce reflection at the bottom surface of first substrate 1810 as described above. Similarly, second substrate 1812 may include a grating 1822 formed thereon, which may be designed to transmit ambient light. Second substrate 1812 may also include an antireflection layer 1832 formed on the bottom surface of second substrate 1812 to reduce reflection at the bottom surface of second substrate 1812. As described above with respect to, for example, FIG. 8A, gratings 1820 and 1822 may be designed to reduce transmissive diffraction of ambient light from a large see-through field of view.

Ambient light 1840 may be transmitted through grating 1820, first substrate 1810, and antireflection layer 1830 and incident on grating 1822 as a light beam 1842. A portion of light beam 1842 may be reflected at the surface of grating 1822 due to refractive index mismatch at the interface between grating 1822 and, for example, air. The reflected portion of light beam 1842 may enter first substrate 1810 and reach grating 1820 as a light beam 1844. Light beam 1844 may be at least partially reflectively diffracted by grating 1820 as a light beam 1846. At least a portion of light beam 1846 may pass through first substrate 1810 and second substrate 1812 and reach user's eye as a light beam 1848 to cause optical artifacts.

FIG. 18B illustrates rainbow artifact reduction in an example of a waveguide display 1805 including two or more substrates according to certain embodiments. As waveguide display 1800, waveguide display 1805 may include a first substrate 1850 and a second substrate 1852. First substrate 1850 may include a grating 1860 formed thereon, which may be designed to transmit ambient light, including ambient light 1890 from an angle outside of the see-through field of view of waveguide display 1805. First substrate 1850 may include an antireflection layer 1870 formed on the bottom surface of first substrate 1850 to reduce reflection at the bottom surface of first substrate 1850 as described above. In addition, first substrate 1850 may include an antireflection layer 1880 formed on grating 1860. Similarly, second substrate 1852 may include a grating 1862 formed thereon, which may be designed to transmit ambient light. Second substrate 1852 may also include an antireflection layer 1872 formed on the bottom surface of second substrate 1852 to reduce reflection at the bottom surface of second substrate 1852. In addition, second substrate 1852 may include an antireflection layer 1882 formed on grating 1862. Gratings 1860 and 1862 may be configured to reduce transmissive diffraction of ambient light from a large see-through field of view as described above, for example, with respect to FIG. 8A.

As illustrated in FIG. 18B, ambient light 1890 may be transmitted through antireflection layer 1880, grating 1860, first substrate 1850, and antireflection layer 1870 and incident on antireflection layer 1882 as a light beam 1892. Antireflection layer 1882 may reduce the reflection of light beam 1892 such that light beam 1892 may mostly pass through antireflection layer 1882, grating 1862, second substrate 1852, and antireflection layer 1872 as a light beam 1894. Light beam 1894 may propagation in a direction away from the eyebox of waveguide display 1805 and thus may not reach user's eye to cause optical artifacts.

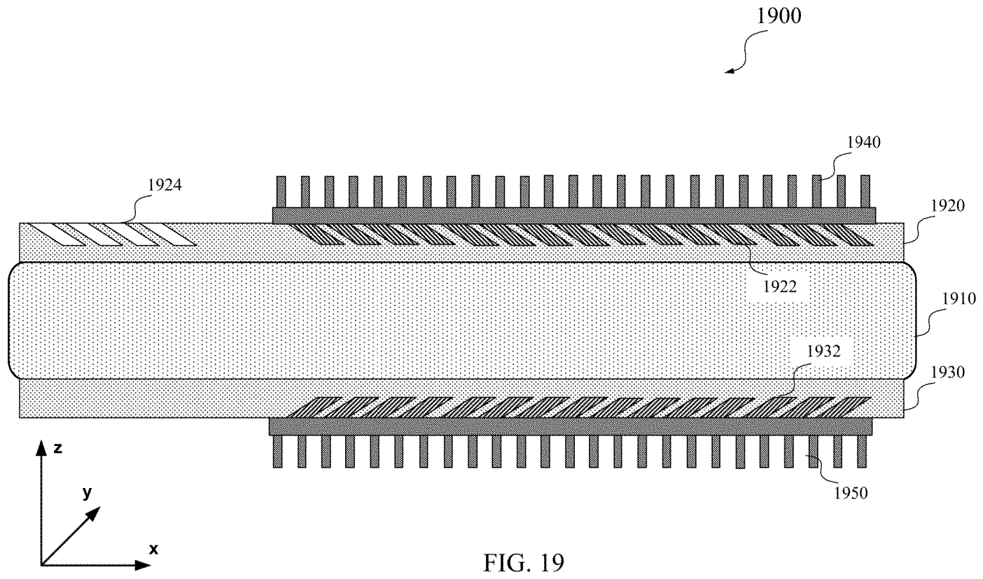

FIG. 19 illustrates an example of a waveguide display 1900 including dual-side antireflection structures according to certain embodiments. Waveguide display 1900 may include a substrate 1910. An input coupler 1924 may be fabricated in a layer 1920 on a top surface of substrate 1910. Waveguide display 1900 may also include one or more output couplers, such as a grating coupler 1922 formed in layer 1920 and/or a grating coupler 1932 formed in a layer 1930 on bottom surface of substrate 1910. Grating coupler 1922 and grating coupler 1932 may include surface-relief gratings or holographic gratings, and may include vertical or slanted gratings. In some embodiments, grating coupler 1922 or grating coupler 1932 may include a variable etch depth surface-relief grating. In some embodiments, grating coupler 1922 or grating coupler 1932 may have a variable grating period and/or a variable duty cycle.

Waveguide display 1900 may further include two antireflection layers 1940 and 1950 formed on opposite surfaces of waveguide display 1900, such as on grating couplers 1922 and 1932, respectively. Antireflection layers 1940 and 1950 may be similar to antireflection structure 1200, 1300, 1400, 1500, or 1600 described above, and may reduce reflection of visible light at the top and bottom surfaces of waveguide display 1900, including light entering or exiting waveguide display 1900, ambient light for see-through view, and ambient light from grazing angles outside of the see-through field of view of waveguide display 1900. Antireflection layers 1940 and 1950 may work for light in a broad wavelength range and a large angular range, and may not result in see-through haze due to, for example, small grating periods such that visible light diffracted by antireflection layer 1940 or 1950 may have a large diffraction angle and thus may not reach user's eye.

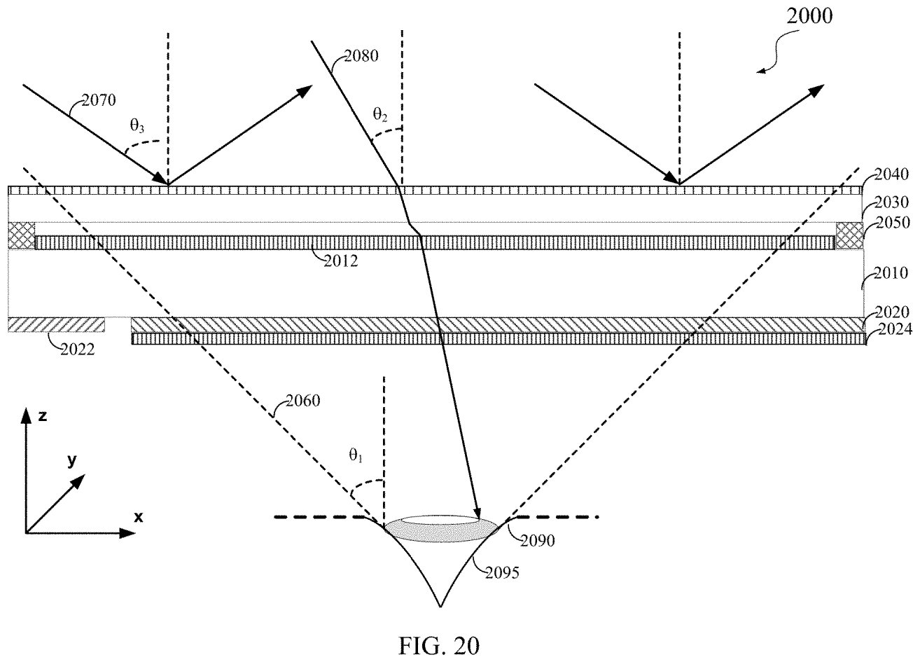

FIG. 20 illustrates an example of a waveguide display 2000 including an angular-selective transmissive layer 2040 and antireflection layers 2012 and 2024 according to certain embodiments. Waveguide display 2000 may include a substrate 2010 (e.g., a waveguide) and a grating coupler 2020 formed on substrate 2010. Grating coupler 2020 may include one or more grating layers configured to reduce the artifacts as described above. For example, the grating layers may include one or more slanted gratings, the periods, heights, and the slant angles of which have a relationship as described above. In some embodiments, the grating layers may include two or more layers of gratings that may be offset with respect to each other, where the two or more layers of gratings may or may not be slanted and ambient light diffracted by one layer of gratings may destructively interfere with ambient light diffracted by another layer of gratings.

Waveguide display 2000 may also include an optical component 2030, which may be flat or curved. For example, optical component 2030 may include a lens, such as a vision correction lens or a lens for correcting one or more types of optical errors. In some embodiments, optical component 2030 may be attached to substrate 2010 and grating coupler 2020 through a spacer layer 2050. Angular-selective transmissive layer 2040 may be formed on optical component 2030. Angular-selective transmissive layer 2040 may have a high reflectivity, diffraction efficiency, or absorption for incident light with an incident angle greater than a certain threshold value, and may have a low loss for incident light with an incident angle lower than the threshold value. The threshold value may be determined based on the see-through field of view of waveguide display 2000. For example, the see-through field of view of waveguide display 2000 as shown by lines 2060 may be ±60° (totally 120°), and the threshold value may be greater than 60°, such as 65° or 70°. As such, incident light 2070 with an incident angle θ₃ greater than a half of the see-through field of view (indicated by angle θ₁) may be mostly reflected, diffracted, or absorbed by angular-selective transmissive layer 2040, and thus may not reach substrate 2010, grating coupler 2020, eye box 2090, and user's eye 2095. For example, angular-selective transmissive layer 2040 may reflect, diffract, or absorb at least 50%, at least 70%, at least 80%, at least 90%, at least 95%, or more of incident light 2070. Incident light 2080 with an incident angle θ₂ within the see-through field of view (indicated by angle θ₁) may mostly pass through angular-selective transmissive layer 2040 and optical component 2030, and may be refracted by grating coupler 2020 and substrate 2010 towards eye box 2090 or user's eye 2095. For example, angular-selective transmissive layer 2040 may reflect, diffract, or absorb less than 30%, less than 20%, less than 10%, or less than 5% of incident light 2080. As such, artifacts caused by external light with a large incident angle may be further reduced.

In some embodiments, angular-selective transmissive layer 2040 may be on a bottom surface of optical component 2030 and may be between optical component 2030 and spacer layer 2050 (or between optical component 2030 and grating coupler 2020 or substrate 2010). In some embodiments, an additional angular-selective reflective layer may be position below substrate 2010 and grating coupler 2020.

Waveguide display 2000 may include antireflection layer 2024 on the bottom surface of grating coupler 2020. Antireflection layer 2024 may include, for example, antireflection structures described above, and may be used to reduce the reflection of the external light at the bottom surface of grating coupler 2020. Thus, little or no external light may be reflected at bottom surface of grating coupler 2020 back to grating coupler 2020, and therefore the rainbow ghost that might otherwise be formed due to the reflective diffraction of external light by grating coupler 2020 as described above with respect to FIG. 11A may be reduced or minimized.

Waveguide display 2000 may include antireflection layer 2012 on the top surface of grating coupler 2020. Antireflection layer 2012 may include an antireflection structure described above, and may be used to reduce the reflection of the external light at the top surface of substrate 2010. The external light may be external light incident on waveguide display 2000 from the user side or from the side opposite to the user. For example, antireflection layer 2012 may reduce the reflection of external light entering substrate 2010 from the user side at the top surface of substrate 2010, where the reflected light may be transmissively diffracted by grating coupler 2020 toward user's eye 2095 to cause optical artifacts. In some embodiments, an antireflection structure (not shown in FIG. 20) may be formed on the bottom surface of optical component 2030 to reduce the reflection at the bottom surface of optical component 2030 that may be reflected back to grating coupler 2020 and may be transmissively diffracted by grating coupler 2020 toward user's eye 2095 to cause optical artifacts.

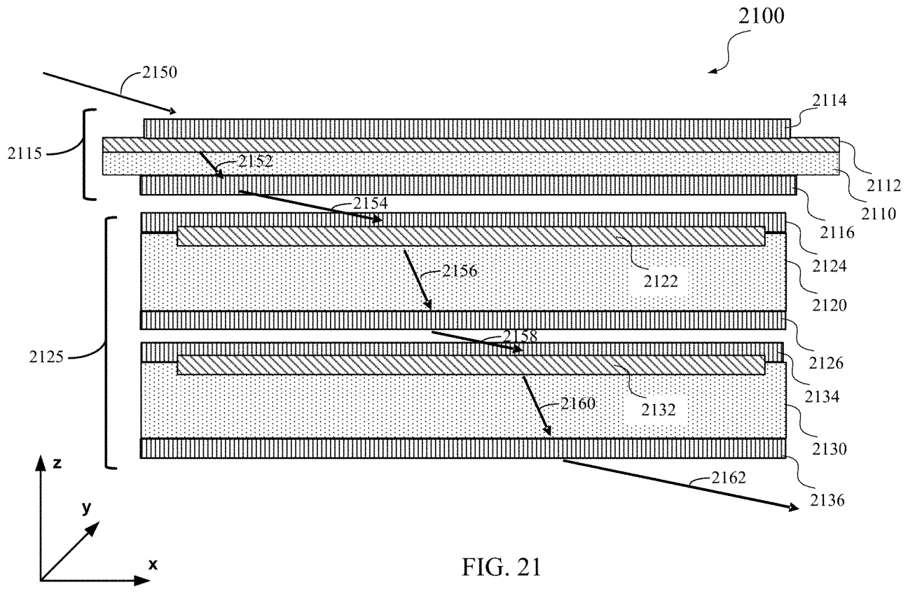

FIG. 21 illustrates an example of a near-eye display system 2100 including two or more substrates each including dual-side antireflection coatings according to certain embodiments. In the example shown in FIG. 21, near-eye display system 2100 may include an eye-tracking combiner 2115 and a waveguide stack 2125. Eye-tracking combiner 2115 may be used to direct invisible light (e.g., infrared light) to user's eyes for eye illumination or direct invisible light reflected from user's eye to a camera for imaging. Waveguide stack 2125 may be used to display images to user's eyes and may include multiple waveguides for displaying different color components and/or different fields of view for the images.

Eye-tracking combiner 2115 may include a substrate 2110, a grating 2112 (or another light deflecting component for infrared light, such as a hot mirror) on a first surface of substrate 2110, an antireflection layer 2114 on grating 2112, and an antireflection layer 2116 formed on a second surface of substrate 2110. Antireflection layers 2114 and 2116 may include antireflection structures as described above. External light 2150 may enter substrate 2110 as a light beam 2152 without being diffracted by grating 2112. Light beam 2152 may be refracted out of substrate 2110 with minimum reflection as a light beam 2154 due to antireflection layer 2116 formed on the second surface of substrate 2110.

In the example shown in FIG. 21, waveguide stack 2125 may include two substrates 2120 and 2130, and gratings and antireflection layers formed on substrates 2120 and 2130. For example, a grating 2122 may be formed on one surface of substrate 2120, an antireflection layer 2124 may be formed on grating 2122, and an antireflection layer 2126 may be formed on a surface of substrate 2120 opposing grating 2122. Similarly, a grating 2132 may be formed on one surface of substrate 2130, an antireflection layer 2134 may be formed on grating 2132, and an antireflection layer 2136 may be formed on a surface of substrate 2130 opposing grating 2132. Light beam 2154 may be refracted into substrate 2120 with little or no reflection as a light beam 2156 because antireflection layer 2124 is at the interface between air and grating 2122 (or substrate 2120) and grating 2122 may not transmissively diffract light beam 2154 as described above with respect to, for example, FIG. 8A. Light beam 2156 may be refracted out of substrate 2120 with minimum reflection as a light beam 2158 due to antireflection layer 2126 formed on the second surface of substrate 2120. Light beam 2158 may be refracted into substrate 2130 with little or no reflection as a light beam 2160 because antireflection layer 2134 is at the interface between air and grating 2132 (or substrate 2130) and grating 2132 may not transmissively diffract light beam 2158. Light beam 2160 may be refracted out of substrate 2130 with minimum reflection as a light beam 2162 due to antireflection layer 2136 formed on the second surface of substrate 2130. Thus, optical artifacts may not be caused by external light 2150 in near-eye display system 2100.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

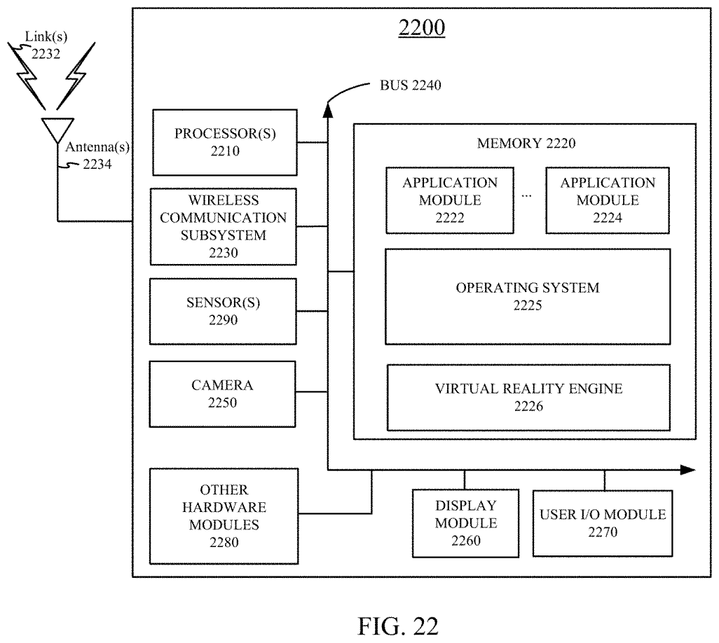

FIG. 22 is a simplified block diagram of an example electronic system 2200 of an example near-eye display (e.g., HMD device) for implementing some of the examples disclosed herein. Electronic system 2200 may be used as the electronic system of an HMD device or other near-eye displays described above. In this example, electronic system 2200 may include one or more processor(s) 2210 and a memory 2220. Processor(s) 2210 may be configured to execute instructions for performing operations at a number of components, and can be, for example, a general-purpose processor or microprocessor suitable for implementation within a portable electronic device. Processor(s) 2210 may be communicatively coupled with a plurality of components within electronic system 2200. To realize this communicative coupling, processor(s) 2210 may communicate with the other illustrated components across a bus 2240. Bus 2240 may be any subsystem adapted to transfer data within electronic system 2200. Bus 2240 may include a plurality of computer buses and additional circuitry to transfer data.

Memory 2220 may be coupled to processor(s) 2210. In some embodiments, memory 2220 may offer both short-term and long-term storage and may be divided into several units. Memory 2220 may be volatile, such as static random access memory (SRAM) and/or dynamic random access memory (DRAM) and/or non-volatile, such as read-only memory (ROM), flash memory, and the like. Furthermore, memory 2220 may include removable storage devices, such as secure digital (SD) cards. Memory 2220 may provide storage of computer-readable instructions, data structures, program modules, and other data for electronic system 2200. In some embodiments, memory 2220 may be distributed into different hardware modules. A set of instructions and/or code might be stored on memory 2220. The instructions might take the form of executable code that may be executable by electronic system 2200, and/or might take the form of source and/or installable code, which, upon compilation and/or installation on electronic system 2200 (e.g., using any of a variety of generally available compilers, installation programs, compression/decompression utilities, etc.), may take the form of executable code.

In some embodiments, memory 2220 may store a plurality of application modules 2222 through 2224, which may include any number of applications. Examples of applications may include gaming applications, conferencing applications, video playback applications, or other suitable applications. The applications may include a depth sensing function or eye tracking function. Application modules 2222-2224 may include particular instructions to be executed by processor(s) 2210. In some embodiments, certain applications or parts of application modules 2222-2224 may be executable by other hardware modules 2280. In certain embodiments, memory 2220 may additionally include secure memory, which may include additional security controls to prevent copying or other unauthorized access to secure information.

In some embodiments, memory 2220 may include an operating system 2225 loaded therein. Operating system 2225 may be operable to initiate the execution of the instructions provided by application modules 2222-2224 and/or manage other hardware modules 2280 as well as interfaces with a wireless communication subsystem 2230 which may include one or more wireless transceivers. Operating system 2225 may be adapted to perform other operations across the components of electronic system 2200 including threading, resource management, data storage control and other similar functionality.

Wireless communication subsystem 2230 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2200 may include one or more antennas 2234 for wireless communication as part of wireless communication subsystem 2230 or as a separate component coupled to any portion of the system. Depending on desired functionality, wireless communication subsystem 2230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 2230 may permit data to be exchanged with a network, other computer systems, and/or any other devices described herein. Wireless communication subsystem 2230 may include a means for transmitting or receiving data, such as identifiers of HMD devices, position data, a geographic map, a heat map, photos, or videos, using antenna(s) 2234 and wireless link(s) 2232. Wireless communication subsystem 2230, processor(s) 2210, and memory 2220 may together comprise at least a part of one or more of a means for performing some functions disclosed herein.

Embodiments of electronic system 2200 may also include one or more sensors 2290. Sensor(s) 2290 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2290 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2200 may include a display module 2260. Display module 2260 may be a near-eye display, and may graphically present information, such as images, videos, and various instructions, from electronic system 2200 to a user. Such information may be derived from one or more application modules 2222-2224, virtual reality engine 2226, one or more other hardware modules 2280, a combination thereof, or any other suitable means for resolving graphical content for the user (e.g., by operating system 2225). Display module 2260 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 2200 may include a user input/output module 2270. User input/output module 2270 may allow a user to send action requests to electronic system 2200. An action request may be a request to perform a particular action. For example, an action request may be to start or end an application or to perform a particular action within the application. User input/output module 2270 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2200. In some embodiments, user input/output module 2270 may provide haptic feedback to the user in accordance with instructions received from electronic system 2200. For example, the haptic feedback may be provided when an action request is received or has been performed.

Electronic system 2200 may include a camera 2250 that may be used to take photos or videos of a user, for example, for tracking the user's eye position. Camera 2250 may also be used to take photos or videos of the environment, for example, for VR, AR, or MR applications. Camera 2250 may include, for example, a complementary metal-oxide-semiconductor (CMOS) image sensor with a few millions or tens of millions of pixels. In some implementations, camera 2250 may include two or more cameras that may be used to capture 3-D images.

In some embodiments, electronic system 2200 may include a plurality of other hardware modules 2280. Each of other hardware modules 2280 may be a physical module within electronic system 2200. While each of other hardware modules 2280 may be permanently configured as a structure, some of other hardware modules 2280 may be temporarily configured to perform specific functions or temporarily activated. Examples of other hardware modules 2280 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2280 may be implemented in software.

In some embodiments, memory 2220 of electronic system 2200 may also store a virtual reality engine 2226. Virtual reality engine 2226 may execute applications within electronic system 2200 and receive position information, acceleration information, velocity information, predicted future positions, or some combination thereof of the HMD device from the various sensors. In some embodiments, the information received by virtual reality engine 2226 may be used for producing a signal (e.g., display instructions) to display module 2260. For example, if the received information indicates that the user has looked to the left, virtual reality engine 2226 may generate content for the HMD device that mirrors the user's movement in a virtual environment. Additionally, virtual reality engine 2226 may perform an action within an application in response to an action request received from user input/output module 2270 and provide feedback to the user. The provided feedback may be visual, audible, or haptic feedback. In some implementations, processor(s) 2210 may include one or more GPUs that may execute virtual reality engine 2226.

In various implementations, the above-described hardware and modules may be implemented on a single device or on multiple devices that can communicate with one another using wired or wireless connections. For example, in some implementations, some components or modules, such as GPUs, virtual reality engine 2226, and applications (e.g., tracking application), may be implemented on a console separate from the head-mounted display device. In some implementations, one console may be connected to or support more than one HMD.

In alternative configurations, different and/or additional components may be included in electronic system 2200. Similarly, functionality of one or more of the components can be distributed among the components in a manner different from the manner described above. For example, in some embodiments, electronic system 2200 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A waveguide display comprising:
a first substrate including two opposing sides;
a grating on a first side of the two opposing sides of the first substrate, the grating configured to couple display light into or out of the first substrate;
a first antireflection layer on a first surface of the grating and configured to reduce reflection of visible light at the first surface of the grating; and
a second antireflection layer on a second side of the two opposing sides of the first substrate and configured to reduce reflection of the visible light at the second side of the first substrate.

2. The waveguide display of claim 1, wherein at least one of the first antireflection layer or the second antireflection layer includes an array of micro-structures.

3. The waveguide display of claim 2, wherein the micro-structures include vertical ridges, pillars, tapered ridges, or cones.

4. The waveguide display of claim 2, wherein the array of micro-structures is in a material layer characterized by a first refractive index lower than a second refractive index of the first substrate.

5. The waveguide display of claim 2, wherein the array of micro-structures includes a one-dimension or two-dimensional array of micro-structures.

6. The waveguide display of claim 2, wherein a period of the array of micro-structures is less than a half of a period of the grating.

7. The waveguide display of claim 1, wherein the first antireflection layer has a reflectivity less than 5% for visible light with incident angles less than 75°.

8. The waveguide display of claim 1, wherein the first antireflection layer or the second antireflection layer includes two or more layers characterized by different respective effective refractive indices less than a refractive index of the first substrate.

9. The waveguide display of claim 1, wherein the grating includes one or more grating layers configured to cause destructive interference between ambient light diffracted by at least two grating layers or between ambient light diffracted by different portions of one grating layer.

10. The waveguide display of claim 1, wherein the grating includes:
a slanted grating including a plurality of slanted ridges, the slanted grating characterized by a height, a period, and a slant angle of the plurality of slanted ridges configured to cause destructive interference between ambient light diffracted by different portions of the slanted grating; or
at least two grating layers, wherein the at least two grating layers are characterized by a same grating period and are offset by a half of the grating period.

11. The waveguide display of claim 1, further comprising a second grating between the first substrate and the second antireflection layer.

12. The waveguide display of claim 11, wherein the grating and the second grating are configured to diffract display light of different respective colors or display light for different respective fields of view.

13. The waveguide display of claim 1, further comprising:
a second substrate;
a second grating on a first side of the second substrate and configured to couple display light into or out of the second substrate, the grating and the second grating configured to diffract display light of different respective colors or display light for different respective fields of view;
a third antireflection layer on a first surface of the second grating and configured to reduce reflection of the visible light at the first surface of the second grating; and
a fourth antireflection layer on a second side of the second substrate opposing the second grating and configured to reduce reflection of the visible light at the second side of the second substrate.

14. The waveguide display of claim 1, further comprising:
a second substrate;
a second grating on a first side of the second substrate and configured to diffract invisible light;
a third antireflection layer on a first surface of the second grating and configured to reduce reflection of the visible light at the first surface of the second grating; and
a fourth antireflection layer on a second side of the second substrate opposing the second grating and configured to reduce reflection of the visible light at the second side of the second substrate.

15. The waveguide display of claim 1, further comprising an angular-selective transmissive layer configured to reflect, diffract, or absorb ambient light incident on the angular-selective transmissive layer with an incidence angle greater than a threshold value.

16. The waveguide display of claim 1, wherein the first substrate includes a curved substrate.

17. A near-eye display comprising:
a waveguide including a first surface and a second surface opposing the first surface;
an input coupler configured to couple display light from an image source into the waveguide;
an output coupler coupled to the first surface of the waveguide and configured to:
refractively transmit ambient light; and
diffractively couple the display light out of the waveguide;
a first antireflection layer for visible light on the output coupler; and
a second antireflection layer for visible light on the second surface of the waveguide.

18. The near-eye display of claim 17, wherein the first antireflection layer includes an array of micro-structures in a material layer characterized by a first refractive index lower than a second refractive index of the waveguide or the output coupler.

19. The near-eye display of claim 18, wherein:
the array of micro-structures includes a one-dimensional or two-dimensional array of ridges, pillars, tapered pillars, or cones; and
a period of the array of micro-structures is less than a half of a period of the output coupler.

20. The near-eye display of claim 17, wherein the output coupler comprises one or more grating layers and is configured to cause destructive interference between ambient light diffracted by at least two grating layers or between ambient light diffracted by different portions of one grating layer.
